(19) United States
(12) Patent Application Publication
(10) Pub. No.: US 2008/0280030 A1
(43) Pub. Date: Nov. 13, 2008

(54) SOLAR CELL ABSORBER LAYER FORMED FROM METAL ION PRECURSORS

(76) Inventors: Jeoren K. J. Van Duren, San Francisco, CA (US); Brian M. Sager, Menlo Park, CA (US); Matthew R. Robinson, San Jose, CA (US)

Correspondence Address: Director of IP, 5521 Hellyer Avenue, San Jose, CA, 95138, US

(21) Appl. No.: 12/024,097

(22) Filed: Jan. 31, 2008

Related U.S. Application Data
(60) Provisional application No. 60/887,582, filed on Jan. 31, 2007.

(51) Int. Cl. B05D 5/12

(52) U.S. Cl. 427/74

(57) ABSTRACT

Methods and devices are provided for forming an absorber layer. In one embodiment, a method is provided comprising of depositing a solution on a substrate to form a precursor layer. The solution comprises of at least one polar solvent, at least one binder, and at least one Group IB and/or IIIA hydroxide. The precursor layer is processed in one or more steps to form a photovoltaic absorber layer. In one embodiment, the absorber layer may be created by processing the precursor layer into a solid film and then thermally reacting the solid film in an atmosphere containing at least an element of Group VIA of the Periodic Table to form the photovoltaic absorber layer. Optionally, the absorber layer may be processed by thermal reaction of the precursor layer in an atmosphere containing at least an element of Group VIA of the Periodic Table to form the photovoltaic absorber layer.

### CROSS-REFERENCE TO RELATED APPLICATION

This application claims the benefit of priority to U.S. Provisional Application Ser. No. 60/887,582 filed Jan. 31, 2007 and fully incorporated herein by reference for all purposes.

### FIELD OF THE INVENTION

This invention relates generally to photovoltaic devices, and more specifically, to use of metal ion precursors in forming photovoltaic devices.

### BACKGROUND OF THE INVENTION

Solar cells and solar modules convert sunlight into electricity. These electronic devices have been traditionally fabricated using silicon (Si) as a light-absorbing, semiconducting material in a relatively expensive production process. To make solar cells more economically viable, solar cell device architectures have been developed that can inexpensively make use of thin-film, preferably non-silicon, light-absorbing semiconductor materials such as copper-indium-gallium-selenide (CIGS).

A central challenge in cost-effectively constructing a large-area CIGS-based solar cell or module involves reducing processing costs and material costs. In known versions of CIGS solar cells, the CIGS absorber materials are typically deposited by a vacuum-based process over a rigid glass substrate. Typical CIGS deposition techniques include co-evaporation, sputtering, chemical vapor deposition, or the like. The nature of vacuum deposition processes requires equipment that is generally low throughput and expensive. Vacuum deposition processes are also typically carried out at high temperatures and for extended times. Furthermore, achieving precise stoichiometric composition over relatively large substrate areas desired in a manufacturing setting is difficult using traditional vacuum-based deposition processes. Traditional sputtering or co-evaporation techniques are limited to line-of-sight and limited-area sources, tending to result in poor surface coverage and non-uniform three-dimensional distribution of the elements. These non-uniformities can occur over the nano-, meso-, and/or macroscopic scales and alters the local stoichiometric ratios of the absorber layer, decreasing the potential power conversion efficiency of the complete cell or module. Additionally, vacuum deposition processes typically have a low material yield, often depositing material on non-targeted surfaces.

To address some of these issues, non-vacuum based techniques have been developed [Solar Energy, 2004, vol. 77, p 749]. Approaches like chemical bath deposition (CBD), electrodeposition, electroplating, spray pyrolysis or spray deposition, and solution-deposition of particles have been investigated. Chemical bath deposition, electrodeposition, electroplating, and some forms of spraying nucleate and grow a thin film directly from solution onto a substrate. A huge disadvantage of techniques that directly nucleate and grow a thin film from solution is the importance of the nature and cleanliness of the substrate surface to allow uniform nucleation and growth of high-quality multinary compound films. Incorporation of unwanted impurities from solution into the thin film during nucleation and growth typically affects the quality of the final multinary semiconductor absorber film disadvantageously resulting in lower solar cell efficiencies, either by incorporation of these impurities as electrical defects into the bulk crystals of the multinary absorber, or by preventing growth of a dense film of large crystals with low lattice defect concentrations, or by introducing unwanted contaminations onto the grain-boundaries of the crystals of the semiconductor thin film, all affecting the solar cell efficiency in a negative way.

Furthermore, these wet chemical deposition techniques typically require a more elaborate drying step to fully remove higher-boiling solvent from the dense as-deposited film, this in contrast to solvent removal from less-dense layers of as-deposited inks based on particles. For the latter, the solvent is removed before densification (of the particles into a densified film) which facilitates drying. Finally, the deposition step as used for CBD, electrodeposition, spraying, and the like, typically requires one or more subsequent high-temperature steps in a chalcogen-controlled atmosphere to improve the morphology of the as-deposited film in addition to the complication of growing these multinary films. Solution-deposition of nano- and/or sub-micron particles followed by converting these particles into a dense film circumvents most of the problems related to the direct nucleation and growth from solution onto a substrate.

Although some techniques may address cost and non-uniformity issues associated with vacuum deposition techniques, these known solution-deposition techniques of particles still use particles that are costly to synthesize into the desired shape and size or are difficult to handle in the powder form. As one example, some of these techniques desire to use particles of pure indium in elemental form. The refining of indium in a pure, elemental form can be a costly endeavor. In 2002, the price was US$94/Kg. In 2006, prices have since risen as high as US$900/Kg for 99.995% pure indium. Size reducing elemental indium can also be problematic as indium is sufficiently malleable that it may present problems to mechanical techniques used for size reduction. Additionally, independent of particle synthesis method, handling of the elemental nanopowder is complicated by its malleability and its tendency to cold weld. Other known examples solution-deposit metal oxides. Metal oxides are chemically stable compounds requiring high temperatures at prolonged times to convert the as-deposited ink into a thin-film containing IB-IIIA-VIA compounds. High temperatures at prolonged times do not allow for a very cost-efficient method.

Due to the aforementioned issues, improved techniques are desired so that lower cost substrates may be used in conjunction with non-vacuum deposition of CIGS, CIGSS, and other silicon or non-silicon based photovoltaic absorber materials. Improvements may be made to increase the throughput of existing CIGS/CIGSS manufacturing processes and decrease the cost associated with CIGS/CIGSS based solar devices. The decreased cost and increased production throughput should increase market penetration and commercial adoption of such products.

### SUMMARY OF THE INVENTION

Embodiments of the present invention address at least some of the drawbacks set forth above. It should be understood that at least some embodiments of the present invention may be applicable to any type of solar cell, whether they are rigid or flexible in nature or the type of material used in the absorber layer. Embodiments of the present invention may be adaptable for roll-to-roll and/or batch manufacturing processes. At least some of these and other objectives described herein will be met by various embodiments of the present invention.

In one embodiment of the present invention, a method is provided comprising of depositing a solution on a substrate to form a precursor layer. The solution comprises of at least one polar solvent, at least one binder, and at least one Group IB and/or IIIA hydroxide. The precursor layer is processed in one or more steps to form a photovoltaic absorber layer. In one embodiment, the absorber layer may be created by processing the precursor layer into a solid film and then thermally reacting the solid film in an atmosphere containing at least an element of Group VIA of the Periodic Table to form the photovoltaic absorber layer. Optionally, the absorber layer may be processed by thermal reaction of the precursor layer in an atmosphere containing at least an element of Group VIA of the Periodic Table to form the photovoltaic absorber layer. The Group IB and/or IIIA hydroxide may be comprised of indium hydroxide. Optionally, the Group IB and/or IIIA hydroxide may be comprised of gallium hydroxide. Group IB and/or IIIA hydroxide may be comprised of indium-gallium hydroxide. Optionally, the precursor layer may be comprised of Cu85Ga15, In(OH)3, and elemental gallium. The precursor layer may be further comprised of copper nanoparticles and indium-gallium hydroxide. The precursor layer may be further comprised of copper-gallium and indium hydroxide without separate elemental gallium. The binder may be an organic binder The binder may be selected from the group consisting of: substituted celluloses, celluloses, the polyvinyl alcohols, polyethylenoxides, the polyacrylonitriles, polysaccharides, nitrocelluloses, polyvinylpyrrolidone, or combinations thereof. The polar solvent may be an organic solvent. The polar solvent may be selected from the group consisting of: aliphatic alcohols, the polyglycols, polyethers, polyols, esters, ethers, ketones, nitriles, alkoxyalcohols, iso-propyl alcohol, or combinations thereof.

Optionally, the following may also be adapted for use with any of the embodiments disclosed herein. Processing comprises annealing with a ramp-rate of 1-5 C/sec, preferably over 5 C/sec, to a temperature of about 225 to 575° C. Optionally, processing comprises annealing with a ramp-rate of 1-5 C/sec, preferably over 5 C/sec, to a temperature of about 225 to 575° C. preferably for about 30 seconds to about 600 seconds to enhance conversion of indium hydroxide or other hydroxide, densification and/or alloying between Cu, In, and Ga in an atmosphere containing hydrogen gas, where the plateau temperature not necessarily is kept constant in time. Optionally, processing further comprises selenizing this annealed layer with a ramp-rate of 1-5 C/sec, preferably over 5 C/sec, to a temperature of about 225 to 575 C for a time period of about 60 seconds to about 10 minutes in Se vapor, where the plateau temperature not necessarily is kept constant in time, to form the thin-film containing one or more chalcogenide compounds containing Cu, In, Ga, and Se. Optionally, processing comprises selenizing without the separate annealing step in an atmosphere containing hydrogen gas, but may be densified and selenized in one step with a ramp-rate of 1-5 C/sec, preferably over 5 C/sec, to a temperature of 225 to 575 C for a time period of about 120 seconds to about 20 minutes in an atmosphere containing either H2Se or a mixture of H2 and Se vapor.

In another embodiment of the present invention, a method is provided comprising depositing a solution on a substrate to form a precursor layer. The solution comprises of at least one polar solvent and at least one Group IB and/or IIIA hydroxide. The solution is without an organic binder and the hydroxide remains un-dissolved in the solvent of the solution. The precursor layer is processed in one or more steps to form a photovoltaic absorber layer. Creating the absorber layer may include processing the precursor layer into a solid film and then thermally reacting the solid film in an atmosphere containing at least an element of Group VIA of the Periodic Table to form the photovoltaic absorber layer. Optionally, creating the absorber layer may include thermal reaction of the precursor layer in an atmosphere containing at least an element of Group VIA of the Periodic Table to form the photovoltaic absorber layer. The binder may be an organic binder.

In another embodiment of the present invention, a method is provided comprising depositing a solution on a substrate to form a precursor layer. The solution comprises of at least one apolar solvent; at least one binder; and at least one Group IB and/or IIIA hydroxide. The precursor layer may be processed in one or more steps to form a photovoltaic absorber layer. Optionally, creating the absorber layer may comprise of processing the precursor layer into a solid film and then thermally reacting the solid film in an atmosphere containing at least an element of Group VIA of the Periodic Table to form the photovoltaic absorber layer. Creating the absorber layer may include the thermal reaction of the precursor layer in an atmosphere containing at least an element of Group VIA of the Periodic Table to form the photovoltaic absorber layer. Optionally, the solution is without an organic binder and the hydroxide remains as un-dissolved particles in the solvent.

In another embodiment of the present invention, a method is provided comprising depositing a solution on a substrate to form a precursor layer. The solution comprises of at least one polar solvent and at least one Group IB and/or IIIA hydroxide. The method may include processing the precursor layer in one or more steps to form a photovoltaic absorber layer, wherein the solution is without an organic binder. Creating the absorber layer may include processing the precursor layer into a solid film and then thermally reacting the solid film in an atmosphere containing at least an element of Group VIA of the Periodic Table to form the photovoltaic absorber layer. Creating the absorber layer may include thermal reaction of the precursor layer in an atmosphere containing at least an element of Group VIA of the Periodic Table to form the photovoltaic absorber layer.

In another embodiment of the present invention, a method is provided comprising depositing a solution on a substrate to form a precursor layer. The solution comprises of at least one apolar solvent and at least one salt of an element entering the composition of the absorber layer, wherein the solution is without an organic binder and wherein the salt remains as un-dissolved particles in the apolar solvent. The precursor layer may be processed in one or more steps to form a photovoltaic absorber layer. Creating the absorber layer may include processing the precursor layer into a solid film and then thermally reacting the solid film in an atmosphere containing at least an element of Group VIA of the Periodic Table to form the photovoltaic absorber layer. Creating the absorber layer may include thermal reaction of the precursor layer in an atmosphere containing at least an element of Group VIA of the Periodic Table to form the photovoltaic absorber layer.

In another embodiment of the present invention, a method of forming an absorber layer is provided comprising of depositing a solution on a substrate to form a precursor layer. The solution comprises of at least one polar solvent and at least one salt of an element entering the composition of the absorber layer, wherein the solution is without an organic binder. The precursor layer may be processed in one or more steps to form a photovoltaic absorber layer. Creating the absorber layer may include processing the precursor layer into a solid film and then thermally reacting the solid film in an atmosphere containing at least an element of Group VIA of the Periodic Table to form the photovoltaic absorber layer. Optionally, creating the absorber layer may include thermal reaction of the precursor layer in an atmosphere containing at least an element of Group VIA of the Periodic Table to form the photovoltaic absorber layer.

In another embodiment of the present invention, a method of forming an absorber layer is provided comprising of depositing a solution on a substrate to form a precursor layer. The solution comprises of In(OH)3 and one or more particles of IB, IB-IIIA, and/or elemental gallium (for both with and without binder, polar or non-polar solvent). The precursor layer may be processed in one or more steps to form a photovoltaic absorber layer.

In another embodiment of the present invention, a method of forming an absorber layer is provided comprising of depositing a solution on a substrate to form a precursor layer. The solution comprises of an In-salt with one or more particles of IB, IB-IIIA, and/or elemental gallium (for both with and without binder, polar or non-polar solvent). The precursor layer may be processed in one or more steps to form a photovoltaic absorber layer.

In another embodiment of the present invention, a method of forming an absorber layer is provided comprising of depositing a solution on a substrate to form a precursor layer. The solution comprises one or more hydroxides and/or salts containing one or more IB and/or IIIA elements in combination with any other type of particles containing one or more IB, IIIA, VIA, and/or IA elements, (for both with and without binder, polar or non-polar solvent). The precursor layer may be processed in one or more steps to form a photovoltaic absorber layer where the conversion of the precursor layer to the thin-film containing the IB-IIIA-VIA compounds is accomplished by using an atmosphere containing any combination of H₂, Se, S, H₂Se, and H₂S.

The various embodiments described herein may result from solutions comprised of: (1) IB and/or IIIA hydroxides in polar solvent with binder, (2) IB and/or IIIA hydroxides in polar solvent without binder, (3) IB and/or IIIA hydroxides in apolar solvent with binder, (4) IB and/or IIIA hydroxides in apolar solvent without binder, (5) IB and/or IIIA salts in apolar solvent without binder, and/or (6) metal salts in polar solvent without binder.

A further understanding of the nature and advantages of the invention will become apparent by reference to the remaining portions of the specification and drawings.

### BRIEF DESCRIPTION OF THE DRAWINGS

FIGS. 1A-1D are schematic cross-sectional diagrams illustrating fabrication of a film according to an embodiment of the present invention.

FIGS. 2A-2F show the use of a chemical gradient according to one embodiment of the present invention.

FIG. 3 shows a roll-to-roll system according to the present invention.

FIG. 4 shows a cross-sectional view of a photovoltaic device according to one embodiment of the present invention.

FIG. 5A shows one embodiment of a system for use with rigid substrates according to one embodiment of the present invention.

FIG. 5B shows one embodiment of a system for use with rigid substrates according to one embodiment of the present invention.

FIG. 6A shows a schematic of a system using a chalcogen vapor environment according to one embodiment of the present invention.

FIG. 6B shows a schematic of a system using a chalcogen vapor environment according to one embodiment of the present invention.

FIG. 6C shows a schematic of a system using a chalcogen vapor environment according to one embodiment of the present invention.

FIG. 7A shows a schematic view of a discrete printed layer of a chalcogen source used with planar particles according to one embodiment of the present invention.

FIG. 7B shows particles having a shell of chalcogen according to one embodiment of the present invention.

### DESCRIPTION OF THE SPECIFIC EMBODIMENTS

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. Thus, for example, reference to “a material” may include mixtures of materials, reference to “a compound” may include multiple compounds, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings:

“Optional” or “optionally” means that the subsequently described circumstance may or may not occur, so that the description includes instances where the circumstance occurs and instances where it does not. For example, if a device optionally contains a feature for an anti-reflective film, this means that the anti-reflective film feature may or may not be present, and, thus, the description includes both structures wherein a device possesses the anti-reflective film feature and structures wherein the anti-reflective film feature is not present.

“Salt” or “salts” means an acid where the proton (hydrogen cation) involved in acid-base chemistry is replaced with one or more metal cations. Metal hydroxides are not salts.

### Photovoltaic Device Chemistry

The solid particles for use with the present invention may be used with a variety of different chemistries to arrive at a desired semiconductor film. Although not limited to the following, an active layer for a photovoltaic device may be fabricated by formulating an ink of spherical and/or non-spherical particles each containing at least one element from groups IB, IIIA and/or VIA, coating a substrate with the ink to form a precursor layer, and heating the precursor layer to form a dense film. By way of nonlimiting example, the particles themselves may be elemental particles or alloy particles. In some embodiments, the precursor layer forms the desired group IB-IIIA-VIA compound in a one step process. In other embodiments, a two step process is used wherein a dense film is formed and then further processed in a suitable atmosphere to form the desired group IB-IIIA-VIA compound. It should be understood that chemical reduction of the precursor layer may not be needed in some embodiments, particularly if the precursor materials are oxygen-free or substantially oxygen free. Thus, a first heating step of two sequential heating steps may optionally be skipped if the particles are processed air-free and are oxygen-free. The resulting group IB-IIIA-VIA compound for either a one step or a two step process is preferably a compound of Cu, In, Ga, and selenium (Se), and/or sulfur S of the form CuIn₍₁₋ₓ₎GaₓS_{2(1-y)}Se_{2y}, where 0≦x≦1 and 0≦y≦1. Optionally, the resulting group IB-IIIA-VIA compound may be a compound of Cu, In, Ga, and selenium (Se), and/or sulfur S of the form Cu_{z}In₍₁₋ₓ₎GaₓS_{2(1-y)}Se_{2y}, where 0.5≦z≦1.5, 0≦x≦1 and 0≦y≦1. Optionally, the resulting group IB-IIIA-VIA thin-film may be a mixture of compounds of Cu, In, Ga and selenium (Se) and/or sulfur S of the form Cu_{z}In₍₁₋ₓ₎GaₓS_{(2+w)(1-y)}Se_{(2+w)y}, where 0.5≦z≦1.5, 0≦x≦1, 0≦y≦1, and −0.2≦w≦0.5. Optionally, the resulting group IA-IB-IIIA-VIA thin-film may be a mixture of compounds of Cu, Na, In, Ga, and selenium (Se) and/or sulfur S of the form Cu_{z(u)}Na_{z(1-u)}In₍₁₋ₓ₎GaₓS_{(2+w)(1-y)}Se_{(2+w)y}, where 0.5≦z≦1.5, 0.5≦u≦1.0, 0≦x≦1, 0≦y≦1, and −0.2≦w≦0.5. The absorber layers formed by hydroxides or metal ion precursors may be designed to create layers with one of the aforementioned stoichiometries.

It should also be understood that group IB, IIIA, and VIA elements other than Cu, In, Ga, Se, and S may be included in the description of the IB-IIIA-VIA materials described herein, and that the use of a hyphen (“—” e.g., in Cu—Se or Cu—In—Se) does not indicate a compound, but rather indicates a coexisting mixture of the elements joined by the hyphen. It is also understood that group IB is sometimes referred to as group 11, group IIIA is sometimes referred to as group 13 and group VIA is sometimes referred to as group 16. Furthermore, elements of group VIA (16) are sometimes referred to as chalcogens. Where several elements can be combined with or substituted for each other, such as In and Ga, or Se, and S, in embodiments of the present invention, it is not uncommon in this art to include in a set of parentheses those elements that can be combined or interchanged, such as (In, Ga) or (Se, S). The descriptions in this specification sometimes use this convenience. Finally, also for convenience, the elements are discussed with their commonly accepted chemical symbols. Group IB elements suitable for use in the method of this invention include copper (Cu), silver (Ag), and gold (Au). Preferably the group IB element is copper (Cu). Group IIIA elements suitable for use in the method of this invention include gallium (Ga), indium (In), aluminum (Al), and thallium (Tl). Preferably the group IIIA element is gallium (Ga) and/or indium (In). Group VIA elements of interest include selenium (Se), sulfur (S), and tellurium (Te), and preferably the group VIA element is either Se and/or S. It should be understood that mixtures such as, but not limited to, alloys, solid solutions, and compounds of any of the above can also be used. The shapes of the solid particles may be any of those described herein.

Forming a Film from Particle Precursors

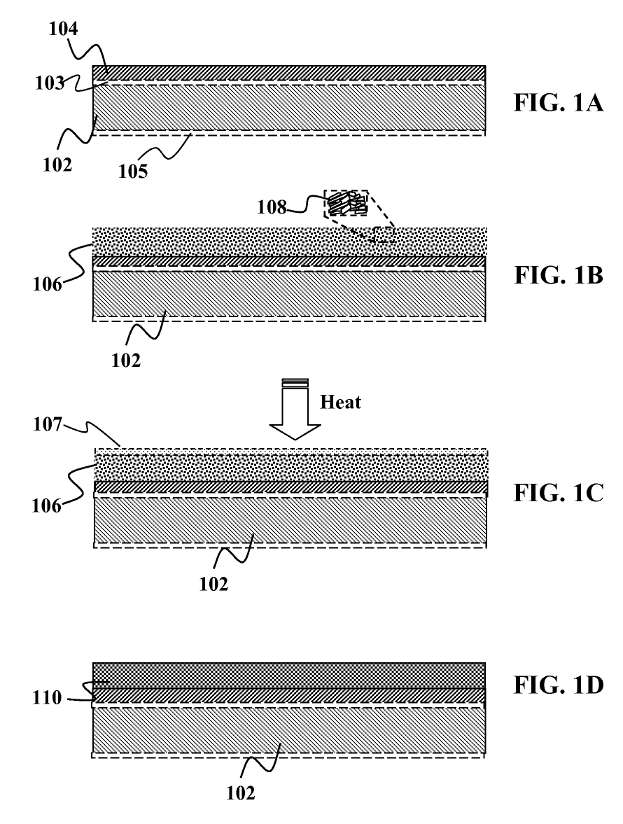

Referring now to FIGS. 1A-1D, one method of forming a semiconductor film from particles of precursor materials according to the present invention will now be described. It should be understood that the present embodiment uses non-vacuum techniques to form the semiconductor film. Other embodiments of the invention, however, may optionally form the film under a vacuum environment, and the use of solid particles (non-spherical and/or spherical) is not limited to only non-vacuum deposition or coating techniques. Optionally, some embodiments may combine both vacuum and non-vacuum techniques.

As seen in FIG. 1A, a substrate 102 is provided on which the precursor layer 106 (see FIG. 1B) will be formed. By way of non-limiting example, the substrate 102 may be made of a metal such as stainless steel or aluminum. In other embodiments, metals such as, but not limited to, copper, steel, molybdenum, titanium, tin, metallized plastic films, or combinations of the foregoing may be used as the substrate 102. Alternative substrates include but are not limited to ceramics, glasses, and the like. Any of these substrates may be in the form of foils, sheets, rolls, the like, or combinations thereof. Depending on the conditions of the surface, and material of the substrate, it may be useful to clean and/or smoothen the substrate surface. Furthermore, depending on the material of the substrate 102, it may be useful to coat a surface of the substrate 102 with a contact layer 104 to promote electrical contact between the substrate 102 and the absorber layer that is to be formed on it, and/or to limit reactivity of the substrate 102 in subsequent steps, and/or to promote higher quality absorber growth. As a non-limiting example, when the substrate 102 is made of aluminum, the contact layer 104 may be but is not limited to a single or multiple layer(s) of molybdenum (Mo), tungsten (W), tantalum (Ta), binary and/or multinary alloys of Mo, W, and/or Ta, with or without the incorporation of a IA element like sodium, and/or oxygen, and/or nitrogen. Some embodiment may include a contact layer 104 may be comprised of a molybdenium-IA material such as but not limited to Na—Mo, Na—F—Mo, or the like deposited using a vacuum or non-vacuum technique. For the purposes of the present discussion, the contact layer 104 may be regarded as being part of the substrate. As such, any discussion of forming or disposing a material or layer of material on the substrate 102 includes disposing or forming such material or layer on the contact layer 104, if one is used. Optionally, other layers of materials may also be used with the contact layer 104 for insulation or other purposes and still considered part of the substrate 102. It should be understood that the contact layer 104 may comprise of more than one type or more than one discrete layer of material. Optionally, some embodiments may use any one and/or combinations of the following for the contact layer: a copper, aluminum, chromium, molybdenum, tungsten, tantalum, vanadium, etc. and/or iron-cobalt alloys. Optionally, a diffusion barrier layer 103 (shown in phantom) may be included and layer 103 may be electrically conductive or electrically non-conductive. As non-limiting examples, the layer 103 may be composed of any of a variety of materials, including but not limited to chromium, vanadium, tungsten, or compounds such as nitrides (including tantalum nitride, tungsten nitride, titanium nitride, silicon nitride, zirconium nitride, and/or hafnium nitride), oxy-nitrides (including tantalum oxy nitride, tungsten oxy nitride, titanium oxy nitride, silicon oxy nitride, zirconium oxy nitride, and/or hafnium oxy nitride), oxides (including Al2O3 or SiO2), carbides (including SiC), binary and/or multinary compounds of W, Ti, Mo, Cr, V, Ta, Hf, Zr, and/or Nb, with/without the addition of either oxygen and/or nitrogen into these elemental, binary and/or multinary compound layers, and/or any single or multiple combination of the foregoing. Optionally, a diffusion barrier layer 105 (shown in phantom) may be on the underside of substrate 102 and be comprised of a material such as but not limited to chromium, vanadium, tungsten, or compounds such as nitrides (including tantalum nitride, tungsten nitride, titanium nitride, silicon nitride, zirconium nitride, and/or hafnium nitride), oxides (including alumina, Al2O3, SiO2, or similar oxides), carbides (including SiC), and/or any single or multiple combination of the foregoing. The layers 103 and/or 105 may be adapted for use with any of the embodiments described herein. The layer 105 may be the same or a different material from that of layer 103.

Referring now to FIG. 1B, a precursor layer 106 is formed over the substrate 102 by coating the substrate 102 with a dispersion such as but not limited to an ink. As one non-limiting example, the ink may be comprised of a carrier liquid mixed with particles such as but not limited to microflakes 108 and has a rheology that allows the ink to be solution-deposited over the substrate 102. In one embodiment, the present invention may use a single dry powder or a mixture of two or more dry powders mixed with the vehicle containing or not containing a dispersant, and sonicated before coating. Optionally, the inks may be already formulated as the precursor materials are formed in a RF thermal plasma-based size reduction chamber such that discussed in U.S. Pat. No. 5,486,675 fully incorporated herein by reference. Optionally, the inks may be already formulated as the precursor materials are formed in a horizontal bead mill. In the case of mixing a plurality of flake compositions, the product may be mixed from various mills. This mixing could be by sonication but other forms of mechanical agitation and/or another mill may also be used. The ink used to form the precursor layer 106 may contain non-spherical particles 108 such as but not limited to microflakes and/or nanoflakes. It should also be understood that the ink may optionally use both non-spherical and spherical particles in any of a variety of relative proportions.

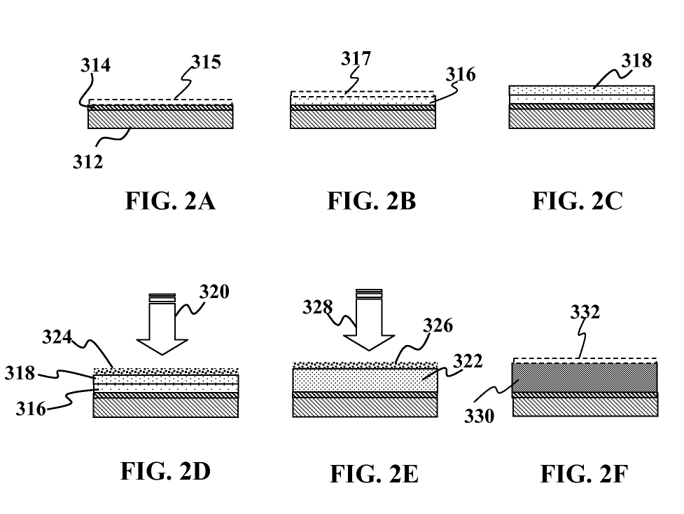

FIG. 1B includes a close-up view of the particles in the precursor layer 106, as seen in the enlarged image. Although not limited to the following, the particles may be microflakes 108 that have non-spherical shapes and are substantially planar on at least one side. A more detailed view of one embodiment of the microflakes 108 can be found in FIGS. 2A and 2B of U.S. patent application Ser. No. 11/362,266 filed Feb. 23, 2006 and fully incorporated herein by reference. Microflakes may be defined as particles having at least one substantially planar surface with a length and/or largest lateral dimension of about 500 nm or more and the particles have an aspect ratio of about 2 or more. In other embodiments, the microflake is a substantially planar structure with thickness of between about 10 and about 250 nm and lengths between about 500 nm and about 5 microns. It should be understood that in other embodiments of the invention, microflakes may have lengths as large as 10 microns. Although not limited to the following, at least some of the solid group IIIA-particles may be processed into planar particles and adapted for use during solution deposition.

In one non-limiting example, the particles used to form the precursor layer 106 are elemental particles, i.e., having only a single atomic species. In one embodiment, the ink used for precursor layer 106 may contain particles comprising one or more group IB elements and particles comprising one or more different group IIIA elements. Preferably, the precursor layer 106 contains copper, indium and gallium. In another embodiment, the precursor layer 106 may be an oxygen-free layer containing copper, indium and gallium. Optionally, the ratio of elements in the precursor layer may be such that the layer, when processed, forms one or more phases where the phases contain one or more of the elements Cu, In, and Ga, and where the layer has the overall composition Cu_{z}InₓGa₁₋ₓ, where 0≦x≦1 and 0.5≦z≦1.5.

Optionally, some of the particles in the ink may be alloy particles. In one nonlimiting example, the particles may be binary alloy particles such as but not limited to Cu—In, In—Ga, or Cu—Ga. Alternatively, the particles may be a binary alloy of group IB, IIIA elements, a binary alloy of Group IB, VIA elements, and/or a binary alloy of group IIIA, VIA elements. In other embodiments, the particles may be a ternary alloy of group IB, IIIA, and/or VIA elements. For example, the particles may be ternary alloy particles of any of the above elements such as but not limited to Cu—In—Ga. In other embodiments, the ink may contain particles that are a quaternary alloy of group IB, IIIA, and/or VIA elements. Some embodiments may have quaternary or multi-nary particles. It should also be understood that the source of group VIA material may be added as discussed in commonly assigned, co-pending U.S. patent application Ser. No. 11/243,522 (Attorney Docket No. NSL-046) filed on Feb. 23, 2006 and fully incorporated herein by reference.

Generally, an ink may be formed by dispersing any of the aforementioned particles (and/or other particles) in a vehicle containing a dispersant (e.g., a surfactant or polymer) along with (optionally) some combination of other components commonly used in making inks. In some embodiments of the present invention, the ink is formulated without a dispersant or other additive. The carrier liquid may be an aqueous (water-based) or non-aqueous (organic) solvent. Other components include, without limitation, dispersing agents, binders, emulsifiers, anti-foaming agents, dryers, solvents, fillers, extenders, thickening agents, film conditioners, anti-oxidants, flow and leveling agents, plasticizers and preservatives. These components can be added in various combinations to improve the film quality and optimize the coating properties of the particle dispersion and/or improve the subsequent densification.

The precursor layer 106 from the dispersion may be formed on the substrate 102 by any of a variety of solution-based coating techniques including but not limited to wet coating, spray coating, spin coating, doctor blade coating, contact printing, top feed reverse printing, bottom feed reverse printing, nozzle feed reverse printing, gravure printing, microgravure printing, reverse microgravure printing, comma direct printing, roller coating, slot die coating, meyerbar coating, lip direct coating, dual lip direct coating, capillary coating, ink-jet printing, jet deposition, spray deposition, and the like, as well as combinations of the above and/or related technologies. The foregoing may apply to any embodiments herein, regardless of particle size or shape.

Note that the method may be optimized by using, prior to, during, or after the solution deposition and/or (partial) densification of one or more of the precursor layers, any combination of (1) any (mixture of) chalcogen source(s) that can be solution-deposited, e.g. a Se or S nanopowder mixed into the precursor layers or deposited as a separate layer, (2) chalcogen (e.g., Se or S) evaporation, (3) a (mixture of) chalcogen-containing hydride gas(es) atmosphere (e.g. H₂Se, and/or H₂S) at pressures below, equal to, and/or above atmospheric pressure, (4) a steady-state and/or dynamic (mixture of) chalcogen vapor(s) atmosphere (e.g., Se, and/or S) at pressures below, equal to, and/or above atmospheric pressure, (5) an organo-selenium containing atmosphere, e.g. diethylselenide, at pressures below, equal to, and/or above atmospheric pressure, (6) an H₂ atmosphere at pressures below, equal to, and/or above atmospheric pressure, (7) another reducing atmosphere, e.g. CO, (8) a wet chemical reduction step, (9) generation of a plasma to break the chemical bonds in the vapor(s) and/or gas(es) in the atmosphere to increase the reactivity of these species, at pressures below, equal to, and/or above atmospheric pressure, (10) a steady-state and/or dynamic atmosphere containing a sodium source, (e.g. Na—Se or Na—S), at pressures below, equal to, and/or above atmospheric pressure, (11) liquid deposition of a chalcogen source, and a (12) heat treatment.

Referring now to FIG. 1C, the precursor layer 106 of particles may then be processed in a suitable atmosphere to form a film. In one embodiment, this processing involves heating the precursor layer 106 to a temperature sufficient to convert the ink to a film (as-deposited ink; note that solvent and possibly dispersant have been removed by drying). The heating may involve various thermal processing techniques such as pulsed thermal processing, exposure to laser beams, heating via IR lamps, and/or similar or related processes. Although not limited to the following, the temperature during heating may be between about 375° C. and about 525° C. (a safe temperature range for processing on aluminum foil or high-temperature-compatible polymer substrates). The processing may occur at various temperatures in this range, such as but not limited to a constant temperature of 450° C. In other embodiments, the temperature may be between about 400° C. and about 600° C. at the level of the precursor layer, but cooler at the substrate. In other embodiments, the temperature may be between about 500° C. and about 600° C. at the level of the precursor layer.

The atmosphere associated with the annealing step in FIG. 1C may also be varied. In one embodiment, the suitable atmosphere comprises an atmosphere containing more than about 10% hydrogen. In another embodiment the suitable atmosphere comprises a carbon monoxide atmosphere. However, in other embodiments where very low or no amounts of oxygen are found in the particles, the suitable atmosphere may be a nitrogen atmosphere, an argon atmosphere, or an atmosphere having less than about 10% hydrogen. These other atmospheres may be advantageous to enable and improve material handling during production.

Referring now to FIG. 1D, the precursor layer 106 processed in FIG. 1C will form a film 110. The film 110 may actually have a reduced thickness compared to the thickness of the wet precursor layer 106 since the carrier liquid and other materials have been removed during processing. In one embodiment, the film 110 may have a thickness in the range of about 0.5 microns to about 2.5 microns. In other embodiments, the thickness of film 110 may be between about 1.5 microns and about 2.25 microns. In one embodiment, the resulting dense film 110 may be substantially void free. In some embodiments, the dense film 110 has a void volume of about 5% or less. In other embodiments, the void volume is about 10% or less. In another embodiment, the void volume is about 20% or less. In still other embodiments, the void volume is about 24% or less. In still other embodiments, the void volume is about 30% or less. The processing of the precursor layer 106 will fuse the particles together and in most instances, remove void space and thus reduce the thickness of the resulting dense film.

Depending on the type of materials used to form the film 110, the film 110 may be suitable for use as an absorber layer or be further processed to become an absorber layer. More specifically, the film 110 may be a film as a result of a one step process, or for use in another subsequent one step process making it a two step process, or for use in a multi-step process. In a one step process, the film 110 is formed to include group IB-IIIA-VIA compounds and the film 110 may be an absorber film suitable for use in a photovoltaic device. In a two step process, the film 110 may be a solid, annealed, and/or densified film that will have further processing to be suitable for use as an absorber film for use in a photovoltaic device. As a nonlimiting example, the film 110 in a two step process may not contain any and/or sufficient amounts of a group VIA element to function as an absorber layer. Adding a group VIA element or other material may be the second step of the two-step process. Either a mixture of two or more VIA elements can be used, or a third step can be added with another VIA element as used in the second step. A variety of methods of adding that material include printing of group VIA element, using VIA element vapor, and/or other techniques. It should also be understood that in a two step process, the process atmospheres may be different. By way of nonlimiting example, one atmosphere may optionally be a group VIA-based atmosphere. As another nonlimiting example, one atmosphere may be an inert atmosphere as described herein. Other processing steps as used in a multi-step process may be a wet chemical surface treatment to improve the IB-IIIA-VIA thin-film surface and/or grain boundaries, and/or an additional rapid thermal heating to improve bulk and/or surface properties of the IB-IIIA-VIA thin-film.

### Hydroxides and Salts

In addition to or in place of elemental and/or alloy particles, the present embodiment of the invention may also use yet another type of precursor material. By way of nonlimiting example, the particles in the ink may be a hydroxide or a salt of a desired element to be included in the final absorber layer. Some embodiments may include more than one type of salt and/or hydroxide. For example, the ink may introduce indium into the absorber layer by using a precursor such as an indium salt or an indium hydroxide. The salt and/or hydroxide particles are dispersed in the ink and incorporated into the precursor layer. When the precursor layer is processed, the salt and/or hydroxide particles are converted to leave behind the desired element, in elemental form and/or alloyed mainly with other desired elements, while the elements in the salts and/or hydroxides that are not desired in the final absorber layer are partially or completely removed from the partially or completely processed precursor layer. Examples of desired elements are group IB, IIIA, VIA, and/or IA elements. One example of removing the unwanted elements is by conversion into one or more volatile components, like H₂O, and H₂Se. Another example is by wet chemically treating the partially or completely processed precursor layer to remove the unwanted elements. Removal of the unwanted elements might be performed in a single step, or by two or more steps. Suitable indium salts include but are not limited to indium sulfates, indium phosphates, indium carbonates, indium salts of selenious acid and/or other acidic selenium-containing compounds, indium arsenates, indium nitrates, indium halogenides, like indium fluorides, indium salts of deprotonated organic acids, like indium acetates, indium dodecylsulfates, indium salts of other deprotonated inorganic acids, and the like. Methods to synthesize nano-sized and/or sub-micron-sized hydroxide particles include but are not limited to precipitation, co-precipitation, hydrothermal chemistry, and size reduction of larger hydroxide powders and/or chunks. One example of precipitation involves increasing the pH to convert a metal salt into precipitates of the metal hydroxide. The indium salt and/or indium hydroxide may be combined with other particles to form the absorber layer, wherein those other particles may be in elemental and/or alloy form. In one example, the indium hydroxide may be combined with other particles of elemental copper and/or elemental gallium. Optionally, the elemental gallium of the other particles may be replaced partially or completely with an alloy such as Cu—Ga, In—Ga, Cu—In—Ga, Ga—Se, Ga—S, Ga—Na, or the like. One such nonlimiting example would be a combination of Cu—Ga such as but not limited to Cu₈₅Ga₁₅, In(OH)₃, and elemental gallium. Yet, another example would be a combination of Cu₇₅Ga₂₅, In(OH)₃, with or without additional elemental gallium. In yet another example a combination of Cu₇₁Ga₂₉, In(OH)₃, with or without additional elemental gallium may be used. In yet another example CuGa₂ may be combined with In(OH)₃, with additional elemental copper. In another example indium hydroxide may be combined with other particles of Cu—In alloy and/or elemental gallium. One such nonlimiting example would be a combination of Cu—In such as but not limited to Cu70In30, In(OH)₃, and elemental gallium. In yet another example In(OH)₃ would be combined with Cu—Se and Ga—Se. Yet another example would be to combine In(OH)₃ with Cu—Se and elemental gallium, or to replace the elemental gallium with a Ga—Na alloy. Yet another example would be a combination of Cu—Se, In(OH)₃, and Ga—S. Yet another example would be a combination of Cu—Se, In(OH)₃, and Ga—Se. Yet another example would be a combination of Cu—S, In(OH)₃, and Ga—Se. Yet another example would be a combination of Cu—S, In(OH)₃, and Ga—S. Yet another example would be a combination of Cu—Se, In(OH)₃, NaOH, and Ga—S. Yet another example would be a combination of copper oxide, In(OH)₃, and elemental gallium.

Other desired elemental materials may also be introduced into the absorber layer by way of salt and/or hydroxide particles. This may include gallium and/or copper. For example, the ink may introduce gallium into the absorber layer by using a precursor such as a gallium salt and/or gallium hydroxide. Suitable gallium salts include but are not limited to gallium sulfates, gallium phosphates, gallium carbonates, gallium salts of selenious acid and/or other acidic selenium-containing compounds, gallium arsenates, gallium nitrates, gallium halogenides, like gallium fluorides, gallium salts of deprotonated organic acids, like gallium acetates, gallium dodecylsulfates, gallium salts of other deprotonated inorganic acids, and the like. Optionally, the ink may introduce copper into the absorber layer by using a precursor such as a copper salt and/or copper hydroxide. Suitable copper salts include but are not limited to copper sulfates, copper phosphates, copper carbonates, copper salts of selenious acid and/or other acidic selenium-containing compounds, copper arsenates, copper nitrates, copper halogenides, like copper fluorides, copper salts of deprotonated organic acids, like copper acetates, copper dodecylsulfates, copper salts of other deprotonated inorganic acids, and the like. For any of the foregoing, the salts and/or hydroxides may be combined with other particles to form the absorber layer, wherein those other particles may be in elemental and/or alloy form. One example would be a combination of copper hydroxide, indium hydroxide, and gallium hydroxide. Yet, another example would be a combination of copper hydroxide, indium hydroxide, and elemental gallium. Yet, another example would be to combine copper with In(OH)3 and a gallium salt. In yet another example a combination of Cu—In and Ga(OH)3 might be used. Yet another example would be to combine In(OH)3, Ga(OH)3, and elemental copper. Yet another example would be to combine Cu—Ga, Ga(OH)3, and indium oxide.

Optionally, salt particles and/or hydroxides particles in the ink may be used to introduce an alloy material into the final absorber layer. For example, the ink may introduce copper-indium into the absorber layer by using a precursor such as a copper-indium salt and/or a copper-indium-hydroxide. Suitable copper-indium salts include but are not limited to copper-indium salts of deprotonated organic acids, copper-indium salts of deprotonated inorganic acids, and the like. This salt and/or hydroxide may be combined with other particles wherein those other particles may be in elemental and/or alloy form. Optionally, this salt may also be combined with other salts and/or hydroxides. In this example, the solution may contain a copper-indium hydroxide combined with elemental copper and elemental gallium. Optionally, the elemental gallium may be replaced with an alloy such as Cu—Ga, In—Ga, Ga—Se or the like.

In one embodiment of the present invention, any combination of chemical surface deposition, solution deposition of particles, wet chemical treatments to rinse the partially or completely processed precursor layer, and/or heating the partially or completely processed precursor layer can be used to form a film containing IB-IIIA-VIA compounds. Chemical surface deposition has the advantage over chemical bath deposition that it allows for higher material usage. Furthermore, a combination of chemical surface deposition with solution-deposition of particles allows for higher-throughput than chemical bath deposition.

Chalcogens, such as but not limited to Se, can be added as salts as well. In one example chalcogens can be added as salts where the anions have the general formula HᵤSeₓS_{y}O_{z} with 0≦u≦1, 0≦x≦1, 0≦y≦1, and 0≦z≦1. One example would be the salt of selenious acid with IB, IIIA, and/or IA, although not limited to IB, IIIA, and/or IA. Yet, another example would be to add chalcogens based on salts of organic cations, such as but not limited to quarternary ammonium salts.

For the embodiments using salt and/or hydroxide particles, the choice of solvent for solution-deposition of the salt(s) and/or hydroxide(s) is mainly dictated by the solubility of the salt(s) and/or hydroxide(s) into the solvent. Preferably solvents are used where the solubility of the salt(s) and/or hydroxide(s) is limited or negligible. Formation of a thin coating by solution-deposition of salt(s) and/or hydroxide(s) that are substantially dissolved into solution requires a relatively large amount of binder to control the coating uniformity and mechanical stability of the thin dried coating. Without a binder, solution-deposition of substantially dissolved salt(s) and/or hydroxide(s) complicates control over the crystallization of the salt(s) and/or hydroxide(s) into a narrow range of crystal sizes during the drying of the wet thin coating. A broad crystal size distribution limits the mechanical stability of the as-deposited coating and/or limits the coating thickness uniformity. Furthermore, when using more than one type of particle, a broad distribution in crystal size will decrease the uniformity in elemental distribution within the coating, resulting in a non-uniform thin-film containing IB-IIIA-VIA compounds which lowers the solar cell efficiency. Binders are difficult to remove in subsequent processing steps and therefore typically result in too high concentrations of carbon-residue in the thin semiconductor device and can result in complications during densification of the crystals into a dense high-quality film containing IB-IIIA-VIA compounds [Thin Solid Films, 2005, vol. 480-481, p. 486]. Similar arguments regarding carbon-residue and/or densification hold for solution-deposition of polymers of IB, IIIA, VIA, and/or IA elements, like deprotonated polyacids of IB, IIIA, and/or IA cations, although the coating uniformity can be more easily controlled than for solution-deposition of substantially dissolved salt(s) and/or hydroxide(s) without a binder. In contrast to using a solvent at which the salt(s) and/or hydroxide(s) are substantially dissolved at processing temperature, when using a solvent in which the salt(s) and/or hydroxide(s) have a limited solubility at processing temperature, solution-deposition of salt(s) and/or hydroxide(s) with limited solubility into a thin film allows for solution-deposition of a carrier liquid containing solid particles with a stable narrow particle size distribution where binders are not necessary to control coating uniformity, mechanical stability, and overall composition homogeneity. The solvent used for solution-deposition of salt(s) and/or hydroxide(s) particles may be a non-polar solvent. Examples of non-polar solvents include but are not limited to some halogenated solvents like carbon tetrachloride, ethers like diethylether, aromatics like toluene, and the like. The use of non-polar solvents or solvents with moderate or limited polarity allows the salt and/or hydroxide particles to be dispersed in the solvent without the particles substantially dissolving into the solvent. Even in some reasonably polar solvents like acetates, several salts and/or hydroxides have very limited solubility, opening up the window of solvents to be used to keep the salts and/or hydroxides mainly dispersed as solid particles and preventing substantial re-crystallization during the drying process into a thin dried coating. The limited coating uniformity resulting from solution-deposition of substantially dissolved salt(s) and/or hydroxide(s) without a binder is undesirable, since it results in local peaks, valleys, cracks, bare spots, and the like. Non-uniformity, both in thickness and elemental distribution, of the precursor layer to be converted into a film containing IB-IIIA-VIA compounds complicates conversion of the precursor layer into a uniform film containing IB-IIIA-VIA compounds and typically lowers the solar cell efficiencies substantially. Additionally, the contaminations resulting from the use of large amounts of binder lower solar cell efficiencies and can result in adhesion failure and/or stability issues due to accumulation of organic contaminations at interfaces. This embodiment of the present invention, however, addresses this issue by creating a dispersion that suspends the particles therein without dissolving them substantially and thus the resulting layer is not impacted by re-crystallization issues during the drying process and the speed at which the solvent evaporates, unlike those solutions where the particles are dissolved substantially. Additionally, no binder is required.

The solution deposited precursor layer may optional include a mixture of one or more of the following solvents: water, an alcohol like methanol, ethanol, or iso-propyl alcohol, a ketone like acetone, or methyl ethyl ketone, a halogenated solvent like ensolv, an acetate like ethyl acetate, or propyl acetate, an ether like 1,4-dioxane, or tetrahydrofuran, an aromatic solvent like toluene or an alkane like hexane, with one of the following organic additives: an acetylenic diol like Dynol 604, an alkoxylated alkylphenol like Triton X100, phosphines, phosphates like Ethox 2928, tallow amines like Ethox TAM-10, a wide variety of ionic additives, like TegoDispers 610, Dolapix PC67, TAM-15 DES QUAT, Arquad SV-50, tetraoctylammonium bromide, thiols like dodecanethiol, amines, acids, acrylates like Darvan C, fluorinated compounds like zonyl 8857A, siloxanes like Silwet L-7604, fatty and/or alcoholic additives like Tween21 and Ethylan 1204, homo- and block-co-polymers like polyvinylpyrrolidone, polyethyleneoxides, polypropyleneglycols, and the like.

The solution-deposited precursor layer may optional include binders of varying molecular weights, varying degree of defects in the backbone as a result of different chemistries, like but not limited to polyvinylpyrrolidones, polyvinylpyridines, polyesters, polyethyleneterephthalates, polyethyleneoxides, polypropyleneglycols, polymethylmethacrylates, polyvinylacetates, polyvinylalcohols, polyacrylicacids, salts of polyacrylic acids, nitrocellulose, polystyrenes, polysodiumstyrenesulfonates, acids of polyallylamines, polyacrylamides, polyamides, polycarbonates, xanthan gum, supramolecular polymers, and the like.

### Embodiment 1

This embodiment shows the use of Group IB and/or IIIA hydroxide(s) in a polar solvent with a binder.

A substrate such as an aluminum foil layer with an Mo coating on one side or both sides is provided. Optionally, other metal foils such as stainless steel or copper may also be used in place of the aluminum foil. The foil itself (prior to adding the Mo coating) may include a diffusion barrier layer above and/or below the foil. An approximately 0.5-2.5 um thick layer of a precursor material may be solution deposited over the Mo layer. The precursor material may comprise of a dispersion of nanoparticles of, copper-gallium, elemental gallium, and indium hydroxide. One such example would be a combination of Cu85Ga15, In(OH)3, and elemental gallium. Optionally, the dispersion may comprise of copper nanoparticles and indium-gallium hydroxide. Still optionally, the dispersion may comprise of copper-gallium and indium hydroxide without separate elemental gallium. In one embodiment, the amount of material is provided so that Cu/(In+Ga)=0.95 and Ga/(Ga+In)=0.29 in the final absorber layer. In one embodiment, the amount of material is provided so that Cu/(In+Ga)=0.85-0.99 and Ga/(Ga+In)=0.27 to 0.33 in the final absorber layer.

The polar solvent can be water or an organic compound selected from among aliphatic alcohols, the polyglycols, polyethers, polyols, esters, ethers, ketones, nitriles, alkoxyalcohols. This list is not being exhaustive, any organic solvent can be employed. In the present embodiment, the polar solvent is iso-propyl alcohol.

Some suitable binders for use with the present embodiment include: substituted celluloses, celluloses, the polyvinyl alcohols, polyethylenoxides, the polyacrylonitriles, polysaccharides and nitrocelluloses soluble in adequate solvent. In the present embodiment, the binder is polyvinylpyrrolidone.

For the present embodiment, an approximately 0.5-2.5 um thick layer of a precursor material containing a Cu—Ga solid-solution, like Cu85Ga15, indium hydroxide, and elemental gallium may be solution deposited with the polar solvent iso-propyl alcohol, and the binder polyvinylpyrrolidone. The precursor layer is annealed with a ramp-rate of 1-5 C/sec, preferably over 5° C./sec, to a temperature of about 225 to about 575° C. preferably for about 30 seconds to about 600 seconds to enhance conversion of indium hydroxide, densification and/or alloying between Cu, In, and Ga in an atmosphere containing hydrogen gas, where the plateau temperature not necessarily is kept constant in time. Subsequently, this annealed layer is selenized with a ramp-rate of 1-5° C./sec, preferably over 5° C./sec, to a temperature of about 225 to 600 C for a time period of about 60 seconds to about 10 minutes in Se vapor in a non-vacuum, where the plateau temperature not necessarily is kept constant in time, to form the thin-film containing one or more chalcogenide compounds containing Cu, In, Ga, and Se. Instead of this two-step approach, the layer of precursor material may be selenized without the separate annealing step in an atmosphere containing hydrogen gas, but may be densified and selenized in one step with a ramp-rate of 1-5 C/sec, preferably over 5 C/sec, to a temperature of 225 to 600 C for a time period of about 120 seconds to about 20 minutes in an atmosphere containing either H2Se or a mixture of H2 and Se vapor.

### Embodiment 2

This embodiment shows the use of a Group IB and/or IIIA hydroxides in a polar solvent without a binder. Without the binder, the dispersion and/or process is changed so that the process conditions do not require removal of the binder or residues from the binder from the electrodes and/or absorber, and/or junction partner.

A substrate such as an aluminum foil layer with an Mo coating on one side or both sides is provided. Optionally, other metal foils such as stainless steel or copper may also be used in place of the aluminum foil. The foil itself (prior to adding the Mo coating) may include a diffusion barrier layer above and/or below the foil. An approximately 0.5-2.5 um nm thick layer of a precursor material may be solution deposited over the Mo layer. The precursor material may comprise of a dispersion of copper nanoparticles, gallium, and indium hydroxide. One such example would be a combination of a Cu—Ga alloy, like Cu75Ga25, indium hydroxide, with or without additional elemental gallium. Optionally, the dispersion may be of copper nanoparticles and indium-gallium hydroxide. In one embodiment, the amount of material is provided so that Cu/(In+Ga)=0.95 and Ga/(Ga+In)=0.29 in the final absorber layer. In one embodiment, the amount of material is provided so that Cu/(In+Ga)=0.85-0.99 and Ga/(Ga+In)=0.27 to 0.33 in the final absorber layer.

The polar solvent can be water or an organic compound selected from among aliphatic alcohols, the polyglycols, polyethers, polyols, esters, ethers, ketones, nitriles, alkoxyalcohols. This list is not being exhaustive, any organic solvent can be employed. In the present embodiment, the polar solvent is iso-propyl alcohol.

For the present embodiment, an approximately 0.5-2.5 um thick layer of a precursor material containing a Cu—Ga alloy, like Cu75Ga25, indium hydroxide, with or without additional elemental gallium may be solution deposited with the polar solvent iso-propyl alcohol. The precursor layer is annealed with a ramp-rate of 1-5 C/sec, preferably over 5 C/sec, to a temperature of about 225 to 575° C. preferably for about 30 seconds to about 600 seconds to enhance conversion of indium hydroxide, densification and/or alloying between Cu, In, and Ga in an atmosphere containing hydrogen gas, where the plateau temperature not necessarily is kept constant in time. Subsequently, this annealed layer is selenized with a ramp-rate of 1-5 C/sec, preferably over 5 C/sec, to a temperature of about 225 to 600 C for a time period of about 60 seconds to about 10 minutes in Se vapor, where the plateau temperature not necessarily is kept constant in time, to form the thin-film containing one or more chalcogenide compounds containing Cu, In, Ga, and Se. Instead of this two-step approach, the layer of precursor material may be selenized without the separate annealing step in an atmosphere containing hydrogen gas, but may be densified and selenized in one step with a ramp-rate of 1-5 C/sec, preferably over 5 C/sec, to a temperature of 225 to 600 C for a time period of about 120 seconds to about 20 minutes in an atmosphere containing either H2Se or a mixture of H2 and Se vapor.

### Embodiment 3

This embodiment shows the use of a Group IB and/or IIIA hydroxides in an apolar solvent with a binder. Some suitable apolar solvents include but are not limited to: halogenated solvents like carbon tetrachloride, ethers like diethylether, aromatics like toluene, and the like.

A substrate such as an aluminum foil layer with an Mo coating on one side or both sides is provided. Optionally, other metal foils such as stainless steel or copper may also be used in place of the aluminum foil. The foil itself (prior to adding the Mo coating) may include a diffusion barrier layer above and/or below the foil. An approximately 0.5-3.5 um nm thick layer of a precursor material may be solution deposited over the Mo layer. The precursor material may comprise of a dispersion of copper nanoparticles, gallium, and indium hydroxide. One such example would be a combination of a Cu—In alloy, like Cu70In30, indium hydroxide, with elemental gallium. Optionally, the dispersion may include copper nanoparticles and indium-gallium hydroxide. Still optionally, the dispersion may include copper-gallium and indium hydroxide. In one embodiment, the amount of material is provided so that Cu/(In+Ga)=0.95 and Ga/(Ga+In)=0.29 in the final absorber layer. In one embodiment, the amount of material is provided so that Cu/(In+Ga)=0.85-0.99 and Ga/(Ga+In)=0.27 to 0.33 in the final absorber layer.

An approximately 0.5-3.5 um thick layer of a precursor material containing a Cu—In alloy, like Cu70In30, indium hydroxide, with elemental gallium may be solution deposited with the apolar solvent toluene and the binder polystyrene. The precursor layer is annealed with a ramp-rate of 1-5 C/sec, preferably over 5 C/sec, to a temperature of about 225 to 575° C. preferably for about 30 seconds to about 600 seconds to enhance conversion of indium hydroxide, densification and/or alloying between Cu, In, and Ga in an atmosphere containing hydrogen gas, where the plateau temperature not necessarily is kept constant in time. Subsequently, this annealed layer is selenized with a ramp-rate of 1-5 C/sec, preferably over 5 C/sec, to a temperature of about 225 to 600 C for a time period of about 60 seconds to about 10 minutes in Se vapor, where the plateau temperature not necessarily is kept constant in time, to form the thin-film containing one or more chalcogenide compounds containing Cu, In, Ga, and Se. Instead of this two-step approach, the layer of precursor material may be selenized without the separate annealing step in an atmosphere containing hydrogen gas, but may be densified and selenized in one step with a ramp-rate of 1-5 C/sec, preferably over 5 C/sec, to a temperature of 225 to 600 C for a time period of about 120 seconds to about 20 minutes in an atmosphere containing either H2Se or a mixture of H2 and Se vapor.

### Embodiment 4

This embodiment shows the use of a Group IB and/or IIIA hydroxides in an apolar solvent without a binder. Some suitable apolar solvents include but are not limited to: halogenated solvents like carbon tetrachloride, ethers like diethylether, aromatics like toluene, and the like.

A substrate such as an aluminum foil layer with an Mo coating on one side or both sides is provided. Optionally, other metal foils such as stainless steel or copper may also be used in place of the aluminum foil. The foil itself (prior to adding the Mo coating) may include a diffusion barrier layer above and/or below the foil. An approximately 0.5-2.5 um nm thick layer of a precursor material may be solution deposited over the Mo layer. The precursor material may comprise of a dispersion of copper nanoparticles, gallium, and indium hydroxide. One such example would be a combination of elemental copper, indium hydroxide, and gallium hydroxide. Optionally, the dispersion may include copper nanoparticles and indium-gallium hydroxide. Still optionally, the dispersion may include copper-gallium and indium hydroxide. In one embodiment, the amount of material is provided so that Cu/(In+Ga)=0.95 and Ga/(Ga+In)=0.29 in the final absorber layer. In one embodiment, the amount of material is provided so that Cu/(In+Ga)=0.85-0.99 and Ga/(Ga+In)=0.27 to 0.33 in the final absorber layer.

An approximately 0.5-2.5 um thick layer of a precursor material containing elemental copper, indium hydroxide, and gallium hydroxide may be solution deposited with the apolar solvent methyl ethyl ketone. The precursor layer is annealed with a ramp-rate of 1-5 C/sec, preferably over 5 C/sec, to a temperature of about 225 to 575° C. preferably for about 30 seconds to about 600 seconds to enhance conversion of the hydroxides, densification and/or alloying between Cu, In, and Ga in an atmosphere containing hydrogen gas, where the plateau temperature not necessarily is kept constant in time. Subsequently, this annealed layer is selenized with a ramp-rate of 1-5 C/sec, preferably over 5 C/sec, to a temperature of about 225 to 600 C for a time period of about 60 seconds to about 10 minutes in Se vapor, where the plateau temperature not necessarily is kept constant in time, to form the thin-film containing one or more chalcogenide compounds containing Cu, In, Ga, and Se. Instead of this two-step approach, the layer of precursor material may be selenized without the separate annealing step in an atmosphere containing hydrogen gas, but may be densified and selenized in one step with a ramp-rate of 1-5 C/sec, preferably over 5 C/sec, to a temperature of 225 to 600 C for a time period of about 120 seconds to about 20 minutes in an atmosphere containing either H2Se or a mixture of H2 and Se vapor.

### Embodiment 5

This embodiment shows the use of a Group IB and/or IIIA salts in apolar solvent without binder.

A substrate such as an aluminum foil layer with an Mo coating on one side or both sides is provided. Optionally, other metal foils such as stainless steel or copper may also be used in place of the aluminum foil. The foil itself (prior to adding the Mo coating) may include a diffusion barrier layer above and/or below the foil. An approximately 0.5-2.5 um nm thick layer of a precursor material may be solution deposited over the Mo layer. The precursor material may comprise of a dispersion of copper nanoparticles, gallium, and indium hydroxide. One such example would be a combination of Cu—Ga alloy, like Cu75Ga25, indium chloride, with or without additional elemental gallium. Optionally, the dispersion may be of copper nanoparticles and indium-gallium hydroxide. Still optionally, the dispersion may be of copper-gallium and indium hydroxide. In one embodiment, the amount of material is provided so that Cu/(In+Ga)=0.95 and Ga/(Ga+In)=0.29 in the final absorber layer. In one embodiment, the amount of material is provided so that Cu/(In+Ga)=0.85-0.99 and Ga/(Ga+In)=0.27 to 0.33 in the final absorber layer.

An approximately 0.5-2.5 um thick layer of a precursor material containing a Cu—Ga alloy, like Cu75Ga25, indium chloride, with or without additional elemental gallium may be solution deposited with the apolar solvent methyl ethyl ketone. The precursor layer is annealed with a ramp-rate of 1-5° C./sec, preferably over 5° C./sec, to a temperature of about 225 to 575° C. preferably for about 30 seconds to about 600 seconds to enhance conversion of indium chloride, densification and/or alloying between Cu, In, and Ga in an atmosphere containing hydrogen gas, where the plateau temperature not necessarily is kept constant in time. Subsequently, this annealed layer is selenized with a ramp-rate of 1-5° C./sec, preferably over 5° C./sec, to a temperature of about 225 to 600° C. for a time period of about 60 seconds to about 10 minutes in Se vapor, where the plateau temperature not necessarily is kept constant in time, to form the thin-film containing one or more chalcogenide compounds containing Cu, In, Ga, and Se. Instead of this two-step approach, the layer of precursor material may be selenized without the separate annealing step in an atmosphere containing hydrogen gas, but may be densified and selenized in one step with a ramp-rate of 1-5° C./sec, preferably over 5° C./sec, to a temperature of 225 to 600° C. for a time period of about 120 seconds to about 20 minutes in an atmosphere containing either H2Se or a mixture of H2 and Se vapor.

### Embodiment 6

This embodiment shows the use of a metal salt in a polar solvent without a binder.

A substrate such as an aluminum foil layer with an Mo coating on one side or both sides is provided. Optionally, other metal foils such as stainless steel or copper may also be used in place of the aluminum foil. The foil itself (prior to adding the Mo coating) may include a diffusion barrier layer above and/or below the foil. An approximately 0.5-2.5 um nm thick layer of a precursor material may be solution deposited over the Mo layer. The precursor material may comprise of a dispersion of copper nanoparticles, gallium, and indium hydroxide. One such example would be a combination of elemental copper nitrate, indium hydroxide, and gallium nitrate. Optionally, the dispersion may include copper nanoparticles and indium-gallium hydroxide. Still optionally, the dispersion may include copper-gallium and indium hydroxide. In one embodiment, the amount of material is provided so that Cu/(In+Ga)=0.95 and Ga/(Ga+In)=0.29 in the final absorber layer. In one embodiment, the amount of material is provided so that Cu/(In+Ga)=0.85-0.99 and Ga/(Ga+In)=0.27 to 0.33 in the final absorber layer.

The polar solvent can be water or an organic compound selected from among aliphatic alcohols, the polyglycols, polyethers, polyols, esters, ethers, ketones, nitriles, alkoxyalcohols. This list is not being exhaustive, any organic solvent can be employed. In the present embodiment, the polar solvent is iso-propyl alcohol.

An approximately 0.5-2.5 um thick layer of a precursor material containing elemental copper nitrate, indium hydroxide, and gallium nitrate may be solution deposited with the polar solvent iso-propyl alcohol. The precursor layer is annealed with a ramp-rate of 1-5° C./sec, preferably over 5° C./sec, to a temperature of about 225 to 575° C. preferably for about 30 seconds to about 600 seconds to enhance conversion of indium hydroxide and gallium nitrate, densification and/or alloying between Cu, In, and Ga in an atmosphere containing hydrogen gas, where the plateau temperature not necessarily is kept constant in time. Subsequently, this annealed layer is selenized with a ramp-rate of about 1 to about 5° C./sec, preferably over 5° C./sec, to a temperature of about 225 to about 600° C. for a time period of about 60 seconds to about 10 minutes in Se vapor, where the plateau temperature not necessarily is kept constant in time, to form the thin-film containing one or more chalcogenide compounds containing Cu, In, Ga, and Se. Instead of this two-step approach, the layer of precursor material may be selenized without the separate annealing step in an atmosphere containing hydrogen gas, but may be densified and selenized in one step with a ramp-rate of about 1 to about 5° C./sec, preferably over 5° C./sec, to a temperature of about 225 to about 600 C for a time period of about 120 seconds to about 20 minutes in an atmosphere containing either H2Se or a mixture of H2 and Se vapor.

### Particle Shapes

It should be understood that any of solid particles as discussed herein may be used in spherical and/or non-spherical particle shapes. FIG. 1A shows that the particles may all be non-spherical, planar flake particles. By way of example and not limitation, it should be understood that the solid Group IIIA-based particles may be particles of various shapes used with any of the combinations shown below in Table III. Flakes may be considered to be one type of non-spherical particles.

TABLE III

| | Spherical | Non-Spherical | Flake | Nanoglobules |
|---|---|---|---|---|
| Spherical | Spherical | Non-spherical + Spherical | Flake + Spherical | Nanoglobules + Spherical |
| Non-Spherical | Spherical + | Non-spherical | Flake + Non- | Nanoglobules + |
| | Non-spherical | | spherical | Non-spherical |
| Flake | Spherical + Flake | Non-spherical + Flake | Flake | Nanoglobules + Flake |
| Nanoglobules | Spherical + | Non-spherical + Nanoglobules | Flake + Nanoglobules | Nanoglobules |
| | Nanoglobules | | | |
| Spherical + | Spherical + | Spherical + Non- | Spherical + | Spherical + Non- |
| Non-spherical | Non-spherical | spherical | Non-spherical + Flake | spherical + Nanoglobules |
| Spherical + Flake | Spherical + Flake | Spherical + Flake + | Spherical + Flake | Spherical + Flake + Nonoglobules |
| | | Non-spherical | | |
| Spherical + | Spherical + | Spherical + Nanoglobules + | Spherical + Nanoglobules + Flake | Spherical + Nanoglobules |
| Nanoglobules | Nanoglobules | Non-spherical | | |
| Flake + | Flake + | Flake + Nonspherical | Flake + Nonspherical | Flake + Nonspherical + Nanoglobules |
| Nonspherical | Nonspherical + | | | |
| | Spherical | | | |
| Flake + | Flake + | Flake + Nanoglobules + | Flake + Nanoglobules | Flake + Nanoglobules |
| Nanoglobules | Nanoglobules + | Non-spherical | | |
| | Spherical | | | |
| Non-spherical + | Non-spherical + | Non-spherical + Nanoglobules | Non-spherical + Nanoglobules + Flake | Non-spherical + Nanoglobules |
| Nanoglobules | Nanoglobules + | | | |
| | Spherical | | | |

It should be understood that the salt particles described herein may be size reduced to be spherical and/or non-spherical in shape and is not limited to any one particular configuration.

### Additional Sodium

Referring now to FIGS. 2A-2E, it should be understood that even with solid group IIIA-based particles, more sodium may be desired to provide improved performance. This embodiment of the invention shows that layers of material may be deposited above and/or below the precursor layer. Some layers may be deposited after the precursor layer has been processed. Although not limited to the following, these layers may provide one technique for adding additional sodium.

Referring now to FIG. 2A, the absorber layer may be formed on a substrate 312, as shown in FIG. 2A. A surface of the substrate 312 may be coated with a contact layer 314 to promote electrical contact between the substrate 312 and the absorber layer that is to be formed on it. By way of example, an aluminum substrate 312 may be coated with a contact layer 314 of molybdenum. As discussed herein, forming or disposing a material or layer of material on the substrate 312 includes disposing or forming such material or layer on the contact layer 314, if one is used. Optionally, it should also be understood that a layer 315 may also be formed on top of contact layer 314 and/or directly on substrate 312. This layer may be solution coated, evaporated, and/or deposited using vacuum based techniques. Although not limited to the following, the layer 315 may have a thickness less than that of the precursor layer 316. In one nonlimiting example, the layer may be between about 1 to about 100 nm in thickness. The layer 315 may be comprised of various materials including but not limited to at least one of the following: a group IB element, a group IIIA element, a group VIA element, a group IA element (new style: group 1), a binary and/or multinary alloy of any of the preceding elements, a solid solution of any of the preceding elements, copper, indium, gallium, selenium, copper indium, copper gallium, indium gallium, sodium, a sodium compound, sodium fluoride, sodium indium sulfide, copper selenide, copper sulfide, indium selenide, indium sulfide, gallium selenide, gallium sulfide, copper indium selenide, copper indium sulfide, copper gallium selenide, copper gallium sulfide, indium gallium selenide, indium gallium sulfide, copper indium gallium selenide, and/or copper indium gallium sulfide.

As shown in FIG. 2B, a precursor layer 316 is formed on the substrate. The precursor layer 316 contains one or more group IB elements and one or more group IIIA elements. Preferably, the one or more group IB elements include copper. The one or more group IIIA elements may include indium and/or gallium. The precursor layer may be formed using any of the techniques described above. In one embodiment, the precursor layer contains no oxygen other than those unavoidably present as impurities or incidentally present in components of the film other than the flakes themselves. Although the precursor layer 316 is preferably formed using non-vacuum methods, it should be understood that it may optionally be formed by other means, such as evaporation, sputtering, chemical vapor deposition, physical vapor deposition, atomic layer deposition, ALD, etc. By way of example, the precursor layer 316 may be an oxygen-free compound containing copper, indium and gallium. In one embodiment, the non-vacuum system operates at pressures above about 3.2 kPa (24 Torr). Optionally, it should also be understood that a layer 317 may also be formed on top of precursor layer 316. It should be understood that the stack may have both layers 315 and 317, only one of the layers, or none of the layers. Although not limited to the following, the layer 317 may have a thickness less than that of the precursor layer 316. In one nonlimiting example, the layer may be between about 1 to about 100 nm in thickness. The layer 317 may be comprised of various materials including but not limited to at least one of the following: a group IB element, a group IIIA element, a group VIA element, a group IA element (new style: group 1), a binary and/or multinary alloy of any of the preceding elements, a solid solution of any of the preceding elements, copper, indium, gallium, selenium, copper indium, copper gallium, indium gallium, sodium, a sodium compound, sodium fluoride, sodium indium sulfide, copper selenide, copper sulfide, indium selenide, indium sulfide, gallium selenide, gallium sulfide, copper indium selenide, copper indium sulfide, copper gallium selenide, copper gallium sulfide, indium gallium selenide, indium gallium sulfide, copper indium gallium selenide, and/or copper indium gallium sulfide.

Referring now to FIG. 2C, heat 320 is applied to densify the first precursor layer 316 into a group IB-IIIA compound film 322. The heat 320 may be supplied in a rapid thermal annealing process, e.g., as described above. As a nonlimiting example, the substrate 312 and precursor layer(s) 316 may be heated from an ambient temperature to a plateau temperature range of between about 200° C. and about 600° C. The temperature may be maintained in the plateau range for a period of time ranging between about a fraction of a second to about 60 minutes, and subsequently reduced. The heat turns the precursor layer into a film 322. Optionally, this may be a dense, metallic film as shown in FIG. 2D. The heating may remove voids and create a denser film than the precursor layer. In other embodiments, where the precursor layer is already dense, there may be little to no densification.

Optionally, as shown in FIG. 2D, a layer 326 containing an additional chalcogen source, and/or an atmosphere containing a chalcogen source, may optionally be applied to layer 322. Heat 328 may optionally be applied to layer 322 and the layer 326 and/or atmosphere containing the chalcogen source to heat them to a temperature sufficient to melt the chalcogen source and to react the chalcogen source with the group IB element and group IIIA elements in the precursor layer 322. The heat 328 may be applied in a rapid thermal annealing process, e.g., as described above. The reaction of the chalcogen source with the group IB and IIIA elements forms a compound film 330 of a group IB-IIIA-chalcogenide compound as shown in FIG. 13E. Preferably, the group IB-IIIA-chalcogenide compound is of the form Cu_{z}In₁₋ₓGaₓSe_{2(1-y)}S_{2y}, where 0≦x≦1, 0≦y≦1, and 0.5≦y≦1.5. Although not limited to the following, the compound film 330 may be thicker than the film 322 due to the reaction with group VIA elements.

Referring now to FIGS. 2A-2E, it should be understood that sodium may also be used with the precursor material to improve the qualities of the resulting film. This may be particularly useful in situation where solid Group IIIA particles are formed without using a sodium based material and additional sodium is desired. In a first method, as discussed in regards to FIGS. 2A and 2B, one or more layers of a sodium containing material may be formed above and/or below the precursor layer 316. The formation may occur by solution coating and/or other techniques such as but not limited to sputtering, evaporation, CBD, electroplating, sol-gel based coating, spray coating, chemical vapor deposition (CVD), physical vapor deposition (PVD), atomic layer deposition (ALD), and the like.

Optionally, in a second method, sodium may also be introduced into the stack by sodium doping the flakes and/or particles in the precursor layer 316. As a nonlimiting example, the flakes and/or other particles in the precursor layer 316 may be a sodium containing material such as, but not limited to, Cu—Na, In—Na, Ga—Na, Cu—In—Na, Cu—Ga—Na, In—Ga—Na, Na—Se, Cu—Se—Na, In—Se—Na, Ga—Se—Na, Cu—In—Se—Na, Cu—Ga—Se—Na, In—Ga—Se—Na, Cu—In—Ga—Se—Na, Na—S, Cu—In—Ga—Na, Cu—S—Na, In—S—Na, Ga—S—Na, Cu—In—S—Na, Cu—Ga—S—Na, In—Ga—S—Na, and/or Cu—In—Ga—S—Na. In one embodiment of the present invention, the amount of sodium in the flakes and/or other particles may be about 1 at. % or less. In another embodiment, the amount of sodium may be about 0.5 at. % or less. In yet another embodiment, the amount of sodium may be about 0.1 at. % or less. It should be understood that the doped particles and/or flakes may be made by a variety of methods including milling feedstock material with the sodium containing material and/or elemental sodium.

Optionally, in a third method, sodium may be incorporated into the ink itself, regardless of the type of particle, nanoparticle, microflake, and/or nanoflakes dispersed in the ink. As a nonlimiting example, the ink may include flakes (Na doped or undoped) and a sodium compound with an organic counter-ion (such as but not limited to sodium acetate) and/or a sodium compound with an inorganic counter-ion (such as but not limited to sodium sulfide). It should be understood that sodium compounds added into the ink (as a separate compound), might be present as particles (e.g. nanoparticles), or dissolved and/or in (reverse) micelles. The sodium may be in “aggregate” form of the sodium compound (e.g. dispersed particles), and the “molecularly dissolved” form.

None of the three aforementioned methods are mutually exclusive and may be applied singly or in any single or multiple combination(s) to provide the desired amount of sodium to the stack containing the precursor material. Additionally, sodium and/or a sodium containing compound may also be added to the substrate (e.g. into the molybdenum target). Also, sodium-containing layers may be formed in between one or more precursor layers if multiple precursor layers (using the same or different materials) are used. It should also be understood that the source of the sodium is not limited to those materials previously listed. As a nonlimiting example, basically, any deprotonated alcohol where the proton is replaced by sodium, any deprotonated organic and inorganic acid, the sodium salt of the (deprotonated) acid, NaₓH_{y}Se_{z}SᵤTeᵥO_{w} where x, y, z, u, v, and w≧0, NaₓCu_{y}In_{z}GaᵤOᵥ where x, y, z, u, and v≧0 sodium hydroxide, sodium acetate, and the sodium salts of the following acids: butanoic acid, hexanoic acid, octanoic acid, decanoic acid, dodecanoic acid, tetradecanoic acid, hexadecanoic acid, 9-hexadecenoic acid, octadecanoic acid, 9-octadecenoic acid, 11-octadecenoic acid, 9,12-octadecadienoic acid, 9,12,15-octadecatrienoic acid, and/or 6,9,12-octadecatrienoic acid.

Optionally, as seen in FIG. 2E, it should also be understood that sodium and/or a sodium compound may be added to the processed chalcogenide film after the precursor layer has been densified or otherwise processed. This embodiment of the present invention thus modifies the film after CIGS formation. With sodium, carrier trap levels associated with the grain boundaries are reduced, permitting improved electronic properties in the film. A variety of sodium containing materials such as those listed above may be deposited as layer 332 onto the processed film and then annealed to treat the CIGS film.

Additionally, the sodium material may be combined with other elements that can provide a bandgap widening effect. Two elements which would achieve this include gallium and sulfur. The use of one or more of these elements, in addition to sodium, may further improve the quality of the absorber layer. The use of a sodium compound such as but not limited to Na₂S, NaInS₂, or the like provides both Na and S to the film and could be driven in with an anneal such as but not limited to an RTA step to provide a layer with a bandgap different from the bandgap of the unmodified CIGS layer or film.

### Roll-to-Roll Manufacturing

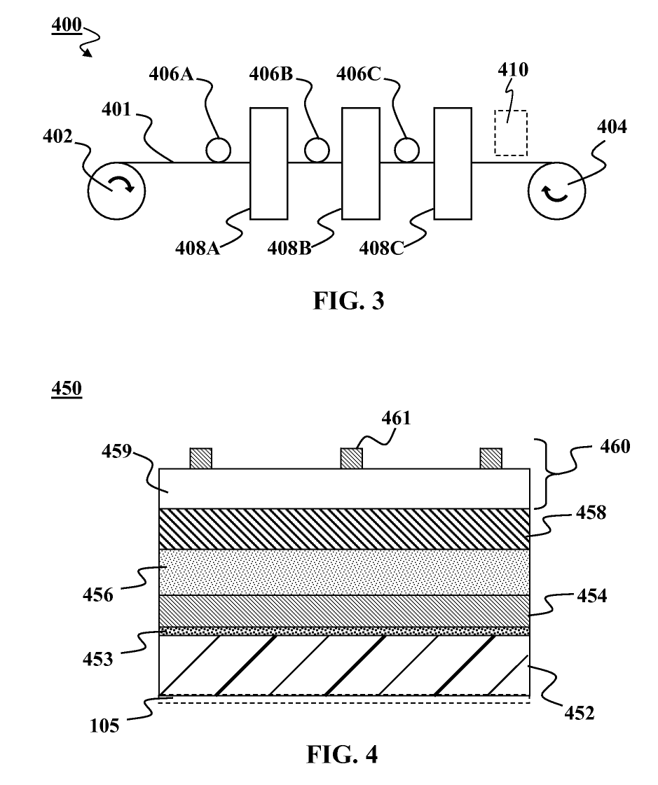

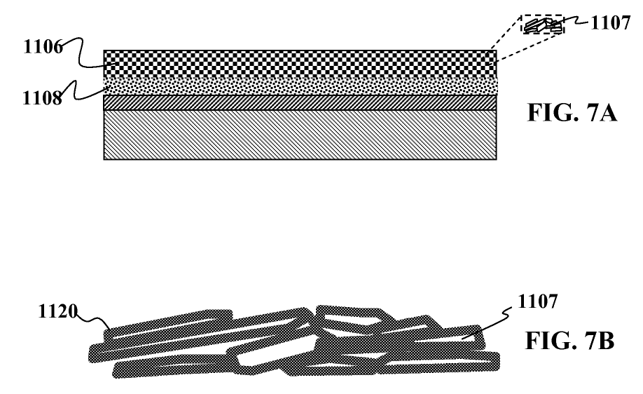

Referring now to FIG. 3, a roll-to-roll manufacturing process according to the present invention will now be described. Embodiments of the invention using the solid group IIIA-based materials are well suited for use with roll-to-roll manufacturing. Specifically, in a roll-to-roll manufacturing system 400 a flexible substrate 401, e.g., aluminum foil travels from a supply roll 402 to a take-up roll 404. In between the supply and take-up rolls, the substrate 401 passes a number of applicators 406A, 406B, 406C, e.g. gravure rollers and heater units 408A, 408B, 408C. It should be understood that these heater units may be thermal heaters or be laser annealing type heaters as described herein. Each applicator deposits a different layer or sub-layer of a precursor layer, e.g., as described above. The heater units are used to anneal the different layers and/or sub-layers to form dense films. In the example depicted in FIG. 7, applicators 406A and 406B may apply different sub-layers of a precursor layer. Heater units 408A and 408B may anneal each sub-layer before the next sub-layer is deposited. Alternatively, both sub-layers may be annealed at the same time. Applicator 406C may optionally apply an extra layer of material containing chalcogen or alloy or elemental particles as described above. Heater unit 408C heats the optional layer and precursor layer as described above. Note that it is also possible to deposit the precursor layer (or sub-layers) then deposit any additional layer and then heat all three layers together to form the IB-IIIA-chalcogenide compound film used for the photovoltaic absorber layer. The roll-to-roll system may be a continuous roll-to-roll and/or segmented roll-to-roll, and/or batch mode processing.

### Photovoltaic Device

Referring now to FIG. 4, the films fabricated as described above using solid group IIIA-based materials may serve as an absorber layer in a photovoltaic device, module, or solar panel. An example of such a photovoltaic device 450 is shown in FIG. 4. The device 450 includes a base substrate 452, an optional adhesion layer 453, a base or back electrode 454, a p-type absorber layer 456 incorporating a film of the type described above, an n-type semiconductor thin film 458 and a transparent electrode 460. By way of example, the base substrate 452 may be made of a metal foil, a polymer such as polyimides (PI), polyamides, polyetheretherketone (PEEK), Polyethersulfone (PES), polyetherimide (PEI), polyethylene naphtalate (PEN), Polyester (PET), related polymers, a metallized plastic, and/or combination of the above and/or similar materials. By way of nonlimiting example, related polymers include those with similar structural and/or functional properties and/or material attributes. The base electrode 454 is made of an electrically conductive material. By way of example, the base electrode 454 may be of a metal layer whose thickness may be selected from the range of about 0.1 micron to about 25 microns. An optional intermediate layer 453 may be incorporated between the electrode 454 and the substrate 452. The transparent electrode 460 may include a transparent conductive layer 459 and a layer of metal (e.g., Al, Ag, Cu, or Ni) fingers 461 to reduce sheet resistance. Optionally, the layer 453 may be a diffusion barrier layer to prevent diffusion of material between the substrate 452 and the electrode 454. The diffusion barrier layer 453 may be a conductive layer or it may be an electrically nonconductive layer. As nonlimiting examples, the layer 453 may be composed of any of a variety of materials, including but not limited to chromium, vanadium, tungsten, and glass, or compounds such as nitrides (including tantalum nitride, tungsten nitride, titanium nitride, silicon nitride, zirconium nitride, and/or hafnium nitride), oxides, carbides, and/or any single or multiple combination of the foregoing. Although not limited to the following, the thickness of this layer can range from 10 nm to 50 nm. In some embodiments, the layer may be from 10 nm to 30 nm. Optionally, an interfacial layer may be located above the electrode 454 and be comprised of a material such as including but not limited to chromium, vanadium, tungsten, and glass, or compounds such as nitrides (including tantalum nitride, tungsten nitride, titanium nitride, silicon nitride, zirconium nitride, and/or hafnium nitride), oxides, carbides, and/or any single or multiple combination of the foregoing.

The n-type semiconductor thin film 458 serves as a junction partner between the compound film and the transparent conducting layer 459. By way of example, the n-type semiconductor thin film 458 (sometimes referred to as a junction partner layer) may include inorganic materials such as cadmium sulfide (CdS), zinc sulfide (ZnS), zinc hydroxide, zinc selenide (ZnSe), n-type organic materials, or some combination of two or more of these or similar materials, or organic materials such as n-type polymers and/or small molecules. Layers of these materials may be deposited, e.g., by chemical bath deposition (CBD) and/or chemical surface deposition (and/or related methods), to a thickness ranging from about 2 nm to about 1000 nm, more preferably from about 5 nm to about 500 nm, and most preferably from about 10 nm to about 300 nm. This may also be configured for use in a continuous roll-to-roll and/or segmented roll-to-roll and/or a batch mode system.

The transparent conductive layer 459 may be inorganic, e.g., a transparent conductive oxide (TCO) such as but not limited to indium tin oxide (ITO), fluorinated indium tin oxide, zinc oxide (ZnO) or aluminum doped zinc oxide, or a related material, which can be deposited using any of a variety of means including but not limited to sputtering, evaporation, chemical bath deposition (CBD), electroplating, sol-gel based coating, spray coating, chemical vapor deposition (CVD), physical vapor deposition (PVD), atomic layer deposition (ALD), and the like. Alternatively, the transparent conductive layer may include a transparent conductive polymeric layer, e.g. a transparent layer of doped PEDOT (Poly-3,4-Ethylenedioxythiophene), carbon nanotubes or related structures, or other transparent organic materials, either singly or in combination, which can be deposited using spin, dip, or spray coating, and the like or using any of various vapor deposition techniques. Optionally, it should be understood that intrinsic (non-conductive) i-ZnO may be used between CdS and Al-doped ZnO. Combinations of inorganic and organic materials can also be used to form a hybrid transparent conductive layer. Thus, the layer 459 may optionally be an organic (polymeric or a mixed polymeric-molecular) or a hybrid (organic-inorganic) material. Examples of such a transparent conductive layer are described e.g., in commonly-assigned US Patent Application Publication Number 20040187317, which is incorporated herein by reference.

Those of skill in the art will be able to devise variations on the above embodiments that are within the scope of these teachings. For example, it is noted that in embodiments of the present invention, portions of the IB-IIIA precursor layers (or certain sub-layers of the precursor layers or other layers in the stack) may be deposited using techniques other than particle-based inks. For example precursor layers or constituent sub-layers may be deposited using any of a variety of alternative deposition techniques including but not limited to solution-deposition of spherical nanopowder-based inks, vapor deposition techniques such as ALD, evaporation, sputtering, CVD, PVD, electroplating and the like.

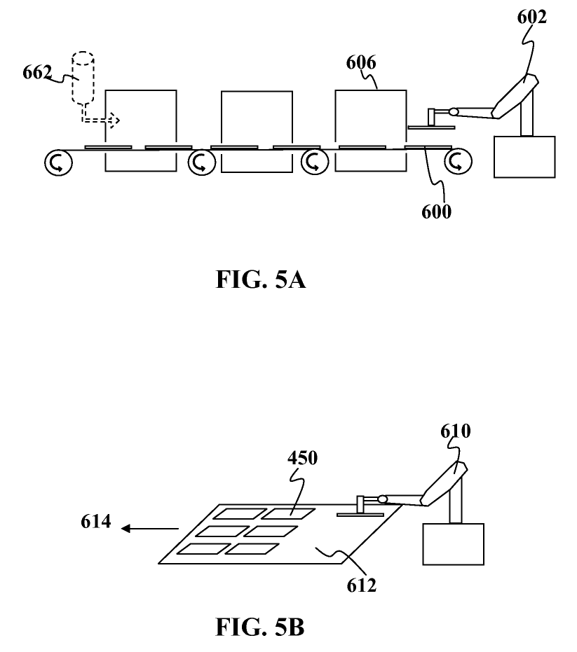

Referring now to FIG. 5A, it should also be understood that the embodiments of the present invention may also be used on a rigid substrate 600. By way of nonlimiting example, the rigid substrate 600 may be glass, soda-lime glass, steel, stainless steel, aluminum, polymer, ceramic, coated polymer, or other rigid material suitable for use as a solar cell or solar module substrate. A high speed pick-and-place robot 602 may be used to move rigid substrates 600 onto a processing area from a stack or other storage area. In FIG. 5A, the substrates 600 are placed on a conveyor belt which then moves them through the various processing chambers. Optionally, the substrates 600 may have already undergone some processing by the time and may already include a precursor layer on the substrate 600. Other embodiments of the invention may form the precursor layer as the substrate 600 passes through the chamber 606. Any of the foregoing may be adapted for use with a laser annealing system that selectively processes target layers over substrates. This may occur in one or more of the chambers through which the substrate 600 passes.

FIG. 5B shows another embodiment of the present system where a pick-and-place robot 610 is used to position a plurality of rigid substrates on a carrier device 612 which may then be moved to a processing area as indicated by arrow 614. This allows for multiple substrates 600 to be loaded before they are all moved together to undergo processing. Source 662 may provide a source of processing gas to provide a suitable atmosphere to create the desired semiconductor film. In one embodiment, chalcogen vapor may be provided by using a partially or fully enclosed chamber with a chalcogen source 662 therein or coupled to the chamber. Any of the foregoing may be adapted for use with a laser annealing system that selectively processes target layers over substrates.

### Chalcogen Vapor Environment

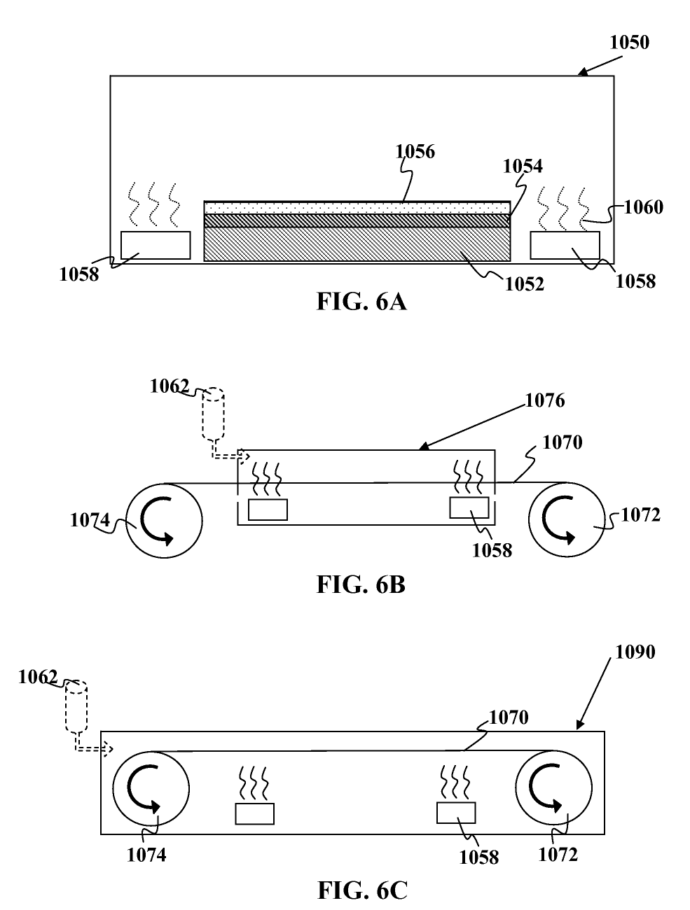

Referring now to FIG. 6A, yet another embodiment of the present invention will now be described. In this embodiment for use with a metal-ion based precursor material, it should be understood that a chalcogen vapor may be used to provide a chalcogen atmosphere to process a film into the desired absorber layer. Optionally, in one embodiment, an overpressure from chalcogen vapor is used to provide a chalcogen atmosphere. FIG. 6A shows a chamber 1050 with a substrate 1052 having a layer 1054 and a precursor layer 1056. Extra sources 1058 of chalcogen may be included in the chamber and are brought to a temperature to generate chalcogen vapor as indicated by lines 1060. In one embodiment of the present invention, the chalcogen vapor is provided to have a partial pressure of the chalcogen present in the atmosphere greater than or equal to the vapor pressure of chalcogen that would be required to maintain a partial chalcogen pressure at the processing temperature and processing pressure to minimize loss of chalcogen from the precursor layer, and if desired, provide the precursor layer with additional chalcogen. The partial pressure is determined in part on the temperature that the chamber 1050 or the precursor layer 1056 is at. It should also be understood that the chalcogen vapor is used in the chamber 1050 at a non-vacuum pressure. In one embodiment, the pressure in the chamber is at about atmospheric pressure. Per the ideal gas law PV=nRT, it should be understood that the temperature influences the vapor pressure. In one embodiment, this chalcogen vapor may be provided by using a partially or fully enclosed chamber with a chalcogen source 1062 therein or coupled to the chamber. In another embodiment using a more open chamber, the chalcogen overpressure may be provided by supplying a source producing a chalcogen vapor. The chalcogen vapor may serve to help keep the chalcogen in the film. Thus, the chalcogen vapor may or may not be used to provide excess chalcogen. It may serve more to keep the chalcogen present in the film than to provide more chalcogen into the film.

Referring now to FIG. 6B, it shown that the present invention may be adopted for use with a roll-to-roll system where the substrate 1070 carrying the precursor layer may be flexible and configured as rolls 1072 and 1074. The chamber 1076 may be at vacuum or non-vacuum pressures. The chamber 1076 may be designed to incorporate a differential valve design to minimize the loss of chalcogen vapor at the chamber entry and chamber exit points of the roll-to-roll substrate 1070.

Referring now to FIG. 6C, yet another embodiment of the present invention uses a chamber 1090 of sufficient size to hold the entire substrate, including any rolls 1072 or 1074 associated with using a roll-to-roll configuration.

### Extra Source of Chalcogen

It should be understood that the present invention using metal ion precursors or hydroxides may also use an extra chalcogen source in a manner similar to that described in copending, U.S. patent application Ser. No. 11/290,633 (Attorney Docket No. NSL-045), wherein the precursor material contains the previous materials and 1) chalcogenides such as, but not limited to, copper selenide, and/or indium selenide and/or gallium selenide and/or 2) a source of extra chalcogen such as, but not limited to, Se or S nanoparticles less than about 200 nanometers in size. In one nonlimiting example, the chalcogenide and/or the extra chalcogen may be in the form of microflakes and/or nanoflakes while the extra source of chalcogen may be flakes and/or non-flakes. The chalcogenide microflakes may be one or more binary alloy chalcogenides such as, but not limited to, group IB-binary chalcogenide nanoparticles (e.g. group IB non-oxide chalcogenides, such as Cu—Se, Cu—S or Cu—Te) and/or group IIIA-chalcogenide nanoparticles (e.g., group IIIA non-oxide chalcogenides, such as Ga(Se, S, Te), In(Se, S, Te) and Al(Se, S, Te). In other embodiments, the microflakes may be non-chalcogenides such as but not limited to group IB and/or IIIA materials like Cu—In, Cu—Ga, and/or In—Ga. If the chalcogen melts at a relatively low temperature (e.g., 220° C. for Se, 120° C. for S) the chalcogen is already in a liquid state and makes good contact with the microflakes. If the microflakes and chalcogen are then heated sufficiently (e.g., at about 375° C.), the chalcogen reacts with the chalcogenides to form the desired IB-IIIA-chalcogenide material.

Although not limited to the following, the chalcogenide particles may be obtained starting from a binary chalcogenide feedstock material, e.g., micron size particles or larger. Examples of chalcogenide materials available commercially are listed below in Table 1.

TABLE I

| | | Typical |
|---|---|---|
| Chemical | Formula | % Purity |
| Aluminum selenide | Al2Se3 | 99.5 |
| Aluminum sulfide | Al2S3 | 98 |
| Aluminum sulfide | Al2S3 | 99.9 |
| Aluminum telluride | Al2Te3 | 99.5 |
| Copper selenide | Cu—Se | 99.5 |
| Copper selenide | Cu2Se | 99.5 |
| Gallium selenide | Ga2Se3 | 99.999 |
| Copper sulfide | Cu2S | 99.5 |
| | (may be Cu1.8—2S) | |
| Copper sulfide | CuS | 99.5 |
| Copper sulfide | CuS | 99.99 |
| Copper telluride | CuTe | 99.5 |
| | (generally Cu1.4Te) | |
| Copper telluride | Cu2Te | 99.5 |
| Gallium sulfide | Ga2S3 | 99.95 |
| Gallium sulfide | GaS | 99.95 |
| Gallium telluride | GaTe | 99.999 |
| Gallium telluride | Ga2Te3 | 99.999 |
| Indium selenide | In2Se3 | 99.999 |
| Indium selenide | In2Se3 | 99.99% |
| Indium selenide | In2Se3 | 99.9 |
| Indium selenide | In2Se3 | 99.9 |
| Indium sulfide | InS | 99.999 |
| Indium sulfide | In2S3 | 99.99 |
| Indium telluride | In2Te3 | 99.999 |
| Indium telluride | In2Te3 | 99.999 |

Examples of chalcogen powders and other feedstocks commercially available are listed in Table II below.

TABLE II

| Chemical | Formula | Typical % Purity |
|---|---|---|
| Selenium metal | Se | 99.99 |
| Selenium metal | Se | 99.6 |
| Selenium metal | Se | 99.6 |
| Selenium metal | Se | 99.999 |
| Selenium metal | Se | 99.999 |
| Sulfur | S | 99.999 |
| Tellurium metal | Te | 99.95 |
| Tellurium metal | Te | 99.5 |
| Tellurium metal | Te | 99.5 |
| Tellurium metal | Te | 99.9999 |
| Tellurium metal | Te | 99.99 |
| Tellurium metal | Te | 99.999 |
| Tellurium metal | Te | 99.999 |
| Tellurium metal | Te | 99.95 |
| Tellurium metal | Te | 99.5 |

### Printing A Layer of the Extra Source of Chalcogen

Referring now to FIG. 1C, another embodiment of the present invention will now be described. An extra source of chalcogen may be provided as a discrete layer 107 containing an extra source of chalcogen such as, but not limited to, elemental chalcogen particles over a microflake or non-flake precursor layer. By way of example, and without loss of generality, the chalcogen particles may be particles of selenium, sulfur or tellurium. Heat is applied to the precursor layer and the layer 107 containing the chalcogen particles to heat them to a temperature sufficient to melt the chalcogen particles and to react the chalcogen particles with the elements in the precursor layer 106. It should be understood that the microflakes may be made of a variety of materials include but not limited to group IB elements, group IIIA elements, and/or group VIA elements. The reaction of the chalcogen particles 107 with the elements of the precursor layer 106 forms a compound film 110 of a group IB-IIIA-chalcogenide compound. Preferably, the group IB-IIIA-chalcogenide compound is of the form CuIn₁₋ₓGaₓSe_{2(1-y)}S_{2y}, where 0≦x≦1 and 0≦y≦1. It should be understood that in some embodiments, the precursor layer 106 may be densified prior to application of the layer 107 with the extra source of chalcogen. In other embodiments, the precursor layer 106 is not pre-heated and the layers 106 and 107 are heated together.

In one embodiment of the present invention, the precursor layer 106 may be between about 4.0 to about 0.5 microns thick. The layer 107 containing chalcogen particles may have a thickness in the range of about 4.0 microns to about 0.5 microns. The chalcogen particles in the layer 107 may be between about 1 nanometer and about 25 microns in size, preferably between about 25 nanometers and about 300 nanometers in size. It is noted that the chalcogen particles may be initially larger than the final thickness of the IB-IIIA-VIA compound film 110. The chalcogen particles 108 may be mixed with solvents, carriers, dispersants etc. to prepare an ink or a paste that is suitable for wet deposition over the precursor layer 106 to form the layer. Alternatively, the chalcogen particles may be prepared for deposition on a substrate through dry processes to form the layer 107. It is also noted that the heating of the layer 107 containing chalcogen particles may be carried out by an RTA process, e.g., as described above.

The chalcogen particles (e.g., Se or S) may be formed in several different ways. For example, Se or S particles may be formed starting with a commercially available fine mesh powder (e.g., 200 mesh/75 micron) and ball milling the powder to a desirable size. A typical ball milling procedure may use a ceramic milling jar filled with grinding ceramic balls and a feedstock material, which may be in the form of a powder, in a liquid medium. When the jar is rotated or shaken, the balls shake and grind the powder in the liquid medium to reduce the size of the particles of the feedstock material. Optionally, the process may include dry (pre-) grinding of bigger pieces of material such as but not limited to Se. The dry-grinding may use pieces 2-6 mm and smaller, but it would be able to handle bigger pieces as well. Note that this is true for all size reductions where the process may start with bigger feedstock materials, dry grinding, and subsequently starting wet grinding (such as but not limited to ball milling). The mill itself may range from a small media mill to a horizontal rotating ceramic jar.

As seen in FIG. 7A, it should also be understood that in some embodiments, the layer 1108 of chalcogen particles may be formed below the precursor layer 1106. This position of the layer 1108 still allows the chalcogen particles to provide a sufficient surplus of chalcogen to the precursor layer 1106 to fully react with the group IB and group IIIA elements in layer 1106. Additionally, since the chalcogen released from the layer 1108 may be rising through the layer 1106, this position of the layer 1108 below layer 1106 may be beneficial to generate greater intermixing between elements. The thickness of the layer 1108 may be in the range of about 4.0 microns to about 0.5 microns. In still other embodiments, the thickness of layer 1108 may be in the range of about 500 nm to about 50 nm. In one nonlimiting example, a separate Se layer of about 100 nm or more might be sufficient. The coating of chalcogen may incorporate coating with powder, Se evaporation, or other Se deposition method such as but not limited to chemical vapor deposition (CVD), physical vapor deposition (PVD), atomic layer deposition (ALD), electroplating, and/or similar or related methods using singly or in combination. Other types of material deposition technology may be used to get Se layers thinner than 0.5 microns or thinner than 1.0 micron. It should also be understood that in some embodiments, the extra source of chalcogen is not limited to only elemental chalcogen, but in some embodiments, may be an alloy and/or solution of one or more chalcogens.

Optionally, it should be understood that the extra source of chalcogen may be mixed with and/or deposited within the precursor layer, instead of as a discrete layer. In one embodiment of the present invention, oxygen-free particles or substantially oxygen-free particles of chalcogen could be used. If the chalcogen is used with microflakes and/or plate shaped precursor materials, densification might not end up an issue due to the higher density achieved by using planar particles, so there is no reason to exclude printing Se and/or other source of chalcogen within the precursor layer as opposed to a discrete layer. This may involve not having to heat the precursor layer to the previous processing temperatures. In some embodiments, this may involve forming the film without heating above 400° C. In some embodiments, this may involve not having to heat above about 300° C.

In still other embodiments of the present invention, multiple layers of material may be printed and reacted with chalcogen before deposition of the next layer. One nonlimiting example would be to deposit a Cu—In—Ga layer, anneal it, then deposit an Se layer then treat that with RTA, follow that up by depositing another precursor layer rich in Ga, followed by another deposition of Se, and finished by a second RTA treatment. More generically, this may include forming a precursor layer (either heat or not) then coating a layer of the extra source of chalcogen (then heat or not) then form another layer of more precursor (heat or not) and then for another layer of the extra source of chalcogen (then heat or not) and repeat as many times as desired to grade the composition or nucleating desired crystal sizes. In one nonlimiting example, this may be used to grade the gallium concentration. In another embodiment, this may be used to grade the copper concentration. In yet another embodiment, this may be used to grade the indium concentration. In a still further embodiment, this may be used to grade the selenium concentration. In yet another embodiment this may be used to grade the selenium concentration. Another reason would be to first grow copper rich films to get big crystals and then to start adding copper-poor layers to get the stoichiometry back. Of course this embodiment can combined to allow the chalcogen to be deposited in the precursor layer for any of the steps involved.

An alternative way to take advantage of the low melting points of chalcogens such as but not limited to Se and S is to form core-shell microflakes in which the core is a microflake 1107 and the shell 1120 is a chalcogen coating. The chalcogen 1120 melts and quickly reacts with the material of the core microflakes 1107. As a nonlimiting example, the core may be a mix of elemental particles of groups IB (e.g., Cu) and/or IIIA (e.g., Ga and In), which may be obtained by ball milling of elemental feedstock to a desired size. Examples of elemental feedstock materials available are listed in Table III below. The core may also be a chalcogenide core or other material as described herein.

TABLE III

| Chemical | Formula | Typical % Purity |
|---|---|---|
| Copper metal | Cu | 99.99 |
| Copper metal | Cu | 99 |
| Copper metal | Cu | 99.5 |
| Copper metal | Cu | 99.5 |
| Copper metal | Cu | 99 |
| Copper metal | Cu | 99.999 |
| Copper metal | Cu | 99.999 |
| Copper metal | Cu | 99.9 |
| Copper metal | Cu | 99.5 |
| Copper metal | Cu | 99.9 |
| | | (O₂ typ. 2-10%) |
| Copper metal | Cu | 99.99 |
| Copper metal | Cu | 99.997 |
| Copper metal | Cu | 99.99 |
| Gallium metal | Ga | 99.999999 |
| Gallium metal | Ga | 99.99999 |
| Gallium metal | Ga | 99.99 |
| Gallium metal | Ga | 99.9999 |
| Gallium metal | Ga | 99.999 |
| Indium metal | In | 99.9999 |
| Indium metal | In | 99.999 |
| Indium metal | In | 99.999 |
| Indium metal | In | 99.99 |
| Indium metal | In | 99.999 |
| Indium metal | In | 99.99 |
| Indium metal | In | 99.99 |

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, traditional thermal annealing may also be used in conjunction with laser annealing. For example, with any of the above embodiments, microflakes may be replaced by and/or mixed with nanoflakes wherein the lengths of the planar nanoflakes are about 500 nm to about 1 nm. As a nonlimiting example, the nanoflakes may have lengths and/or largest lateral dimension of about 300 nm to about 10 nm. In other embodiments, the nanoflakes may be of thickness in the range of about 200 nm to about 20 nm. In another embodiment, these nanoflakes may be of thickness in the range of about 100 nm to about 10 nm. In one embodiment, these nanoflakes may be of thickness in the range of about 200 nm to about 20 nm. As mentioned, some embodiments of the invention may include both microflakes and nanoflakes. Other may include flakes that are exclusively in the size range of microflakes or the size range of nanoflakes. With any of the above embodiments, the microflakes may be replaced and/or combined with microrods which are substantially linear, elongate members. Still further embodiments may combine nanorods with microflakes in the precursor layer. The microrods may have lengths between about 500 nm to about 1 nm. In another embodiment, the nanorods may have lengths between about 500 nm and 20 nm. In yet another embodiment, the nanorods may have lengths between about 300 nm and 30 nm. Any of the above embodiments may be used on rigid substrate, flexible substrate, or a combinations of the two such as but not limited to a flexible substrate that become rigid during processing due to its material properties. In one embodiment of the present invention, the particles may be plates and/or discs and/or flakes and/or wires and/or rods of micro-sized proportions. In another embodiment of the present invention, the particles may be nanoplates and/or nanodiscs and/or nanoflakes and/or nanowires and/or nanorods of nano-sized proportions. Again, any of the foregoing may also be combined with spherical particles in a suspension. Some embodiments may have all spherical particles, all non-spherical particles, and/or mixtures of particles of various shapes. It should be understood that the solid group IIIA-based particles may be used in single or multiple combination with particles of other shapes and/or composition. This may include shapes such as but not limited to spherical, planar, flake, other non-spherical, and/or single or multiple combinations of the foregoing. As for materials, this may include alloys, elementals, chalcogenides, inter-metallics, solid-solutions and/or single or multiple combinations of the foregoing in any shape or form. Use of solid particles with dispersions and/or emulsions of the foregoing is also envisioned. The solid solutions are described in pending U.S. patent application Ser. No. 10/474,259 and published as US20040219730, fully incorporated herein by reference for all purposes. The following applications are also fully incorporated herein by reference: 11/395,438, 11/395,668, and 11/395,426 both filed Mar. 30, 2006. Any of the embodiments described in those applications may be adapted for use with the particles described herein.

For any of the above embodiments, it should be understood that in addition to the aforementioned, the temperature used during annealing may also vary over different time periods of precursor layer processing. As a nonlimiting example, the heating may occur at a first temperature over an initial processing time period and proceed to other temperatures for subsequent time periods of the processing. Optionally, the method may include intentionally creating one or more temperature dips so that, as a nonlimiting example, the method comprises heating, cooling, heating, and subsequent cooling. Some embodiments may use a two-step absorber growth (non-reactive anneal for densification followed by reactive anneal) without cool-down and ramp-up between densification and selenization/sulfurization. Various heating methods, including not heating the substrate, but only the precursor layer (laser) may be used. Others heating techniques may use muffle heating, convection heating, IR-heating. Some embodiments may use the same or different techniques for heating the top surface and bottom surface of the substrate. Basically, all heating mechanisms, being conduction, convection, and radiation may be used. All temperature gradients within the web (across the thickness), being uniformly heated from bottom to top, and/or heating with a huge temperature gradient from bottom (low T) to top (high T), e.g. with a laser, and covering all web transport mechanisms through the furnace (including but not limited to being free-span through the module, dragging over a dense or partially open surface, or relying on a belt), orientation of the furnace, horizontally, vertically, or anything in between.

For any of the above embodiments, it is also possible to have two or more elements of IB elements in the chalcogenide particle and/or the resulting film. Although the description herein uses an ink, it should be understood that in some embodiments, the ink may have the consistency of a paste or slurry. It should be understood that the deposition methods for use with depositing precursor material(s) may include one or more of the following: solution-deposition of particulates, like coating, printing, and spraying, sol-gel, electro(less) deposition (HBP, CBD, e-Dep), precipitations, (chemical) vapor deposition, sputtering, evaporation, ion plating, extrusion, cladding, thermal spray, where several of these methods can be plasma-enhanced) and precursor/film-conversion methods, where the latter can be either chemically, physically, and/or mechanically, and covers both partial and complete changes of the precursor/film and/or surface only.

Additionally, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 nm to about 200 nm should be interpreted to include not only the explicitly recited limits of about 1 nm and about 200 nm, but also to include individual sizes such as 2 nm, 3 nm, 4 nm, and sub-ranges such as 10 nm to 50 nm, 20 nm to 100 nm, etc. . . .

For example, still other embodiments of the present invention may use a Cu—In precursor material wherein Cu—In contributes less than about 50 percent of both Cu and In found in the precursor material. The remaining amount is incorporated by elemental form or by non IB-IIIA alloys. Thus, a Cu₁₁In₉ may be used with elemental Cu, In, and Ga to form a resulting film. In another embodiment, instead of elemental Cu, In, and Ga, other materials such as Cu—Se, In—Se, and/or Ga—Se may be substituted as source of the group IB or IIIA material. Optionally, in another embodiment, the IB source may be any particle that contains Cu without being alloyed with In and Ga (Cu, Cu—Se). The IIIA source may be any particle that contains In without Cu (In—Se, In—Ga—Se) or any particle that contains Ga without Cu (Ga, Ga—Se, or In—Ga—Se). Other embodiments may have these combinations of the IB material in a nitride or oxide form. Still other embodiments may have these combinations of the IIIA material in a nitride or oxide form. The present invention may use any combination of elements and/or selenides (binary, ternary, or multinary) may be used. Optionally, some other embodiments may use oxides such as In₂O₃ to add the desired amounts of materials. It should be understood for any of the above embodiments that more than one solid solution may be used, multi-phasic alloys, and/or more general alloys may also be used. For any of the above embodiments, the annealing process may also involve exposure of the compound film to a gas such as H₂, CO, N₂, Ar, H₂Se, Se vapor, S vapor, or other group VIA containing vapor. There may be a two stage process where there is an initial anneal in a non group-VIA based atmosphere and then a second or more heating in group VIA-based atmosphere. There may be a two stage process where there is an initial anneal in a non group-VIA based atmosphere and then a second heating in a non-group VIA based atmosphere, wherein VIA material is placed directly on the stack for the second heating and additional is the VIA-containing vapor is not used. Alternatively, some may use a one stage process to create a final film, or a multi-stage process where each heating step use a different atmosphere.

It should also be understood that several intermediate solid solutions may also be suitable for use according to the present invention. As nonlimiting examples, a composition in the 6 phase for Cu—In (about 42.52 to about 44.3 wt % In) and/or a composition between the 6 phase for Cu—In and Cu₁₆In₉ may be suitable inter-metallic materials for use with the present invention to form a group IB-IIIA-VIA compound. It should be understood that these inter-metallic materials may be mixed with elemental or other materials such as Cu—Se, In—Se, and/or Ga—Se to provide sources of the group IB or IIIA material to reach the desired stoichiometric ratios in the final compound. Other nonlimiting examples of inter-metallic material include compositions of Cu—Ga containing the following phases: γ₁ (about 31.8 to about 39.8 wt % Ga), γ₂ (about 36.0 to about 39.9 wt % Ga), γ₃ (about 39.7 to about −44.9 wt % Ga), the phase between γ₂ and γ₃, the phase between the terminal solid solution and γ₁, and θ (about 66.7 to about 68.7 wt % Ga). For Cu—Ga, a suitable composition is also found in the range in between the terminal solid-solution of and the intermediate solid-solution next to it. Advantageously, some of these inter-metallic materials may be multi-phasic which are more likely to lead to brittle materials that can be mechanically milled. Phase diagrams for the following materials may be found in ASM Handbook, Volume 3 Alloy Phase Diagrams (1992) by ASM International and fully incorporated herein by reference for all purposes. Some specific examples (fully incorporated herein by reference) may be found on pages 2-168, 2-170, 2-176, 2-178, 2-208, 2-214, 2-257, and/or 2-259. It should also be understood that a particle may have portions that are of a solid alloy and portions that are phase separated into individual elements or other alloys that are liquid.

It should be understood that any of the embodiments herein may be adapted for use in a one step process, or a two step process, or a multi-step process for forming a photovoltaic absorber layer. One step processes do not require a second follow-up process to convert the film into an absorber layer. A two step process typically creates a film that uses a second process to convert the film into an absorber layer. Additionally, some embodiments may have anywhere from about 0 to about 5 wt % oxygen in the shell.

It should be understood that the particles as described herein may be used with solids, solid solutions, intermetallics, nanoglobules, emulsions, nanoglobule, emulsion, or other types of particles. It should also be understood that prior to deposition of any material on the substrate, the metal foil may undergo conditioning (cleaning, smoothening, and possible surface treatment for subsequent steps), such as but not limited to corona cleaning, wet chemical cleaning, plasma cleaning, ultrasmooth re-rolling, electro-polishing, and/or CMP slurry polishing.

Furthermore, those of skill in the art will recognize that any of the embodiments of the present invention can be applied to almost any type of solar cell material and/or architecture. For example, the absorber layer in the solar cell may be an absorber layer comprised of copper-indium-gallium-selenium (for CIGS solar cells), CdSe, CdTe, Cu(In,Ga)(S,Se)₂, Cu(In,Ga,Al)(S,Se,Te)₂, and/or combinations of the above, where the active materials are present in any of several forms including but not limited to bulk materials, micro-particles, nano-particles, or quantum dots. The CIGS cells may be formed by vacuum or non-vacuum processes. The processes may be one stage, two stage, or multi-stage CIGS processing techniques. Many of these types of cells can be fabricated on flexible substrates.

Additionally, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a thickness range of about 1 nm to about 200 nm should be interpreted to include not only the explicitly recited limits of about 1 nm and about 200 nm, but also to include individual sizes such as but not limited to 2 nm, 3 nm, 4 nm, and sub-ranges such as 10 nm to 50 nm, 20 nm to 100 nm, etc. . . .

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited. For example, US 20040219730 and US 2005/0183767 are fully incorporated herein by reference.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method comprising:
depositing a solution on a substrate to form a precursor layer, the solution comprising:
at least one Group IB and/or IIIA hydroxide;
processing the precursor layer in one or more steps to form a photovoltaic absorber layer.

2. A method comprising:
depositing a solution on a substrate to form a precursor layer, the solution comprising:
at least one polar solvent;
at least one binder; and
at least one Group IB and/or IIIA hydroxide;
processing the precursor layer in one or more steps to form a photovoltaic absorber layer.

3. The method of claim 2 further comprising creating the absorber layer by processing the precursor layer into a solid film and then thermally reacting the solid film in an atmosphere containing at least an element of Group VIA of the Periodic Table to form the photovoltaic absorber layer.

4. The method of claim 2 further comprising creating the absorber layer by thermal reaction of the precursor layer in an atmosphere containing at least an element of Group VIA of the Periodic Table to form the photovoltaic absorber layer.

5. The method of claim 2 wherein Group IB and/or IIIA hydroxide comprises indium hydroxide.

6. The method of claim 2 wherein Group IB and/or IIIA hydroxide comprises gallium hydroxide.

7. The method of claim 2 wherein Group IB and/or IIIA hydroxide comprises indium-gallium hydroxide.

8. The method of claim 2 wherein the precursor layer comprises of Cu—Ga, indium hydroxide, and elemental gallium.

9. The method of claim 2 wherein the precursor layer comprises of Cu₈₅Ga₁₅, In(OH)₃, and elemental gallium.

10. The method of claim 2 wherein the precursor layer further comprises of copper nanoparticles and indium-gallium hydroxide.

11. The method of claim 2 wherein the precursor layer further comprises copper-gallium and indium hydroxide without separate elemental gallium.

12. The method of claim 2 wherein the binder is an organic binder

13. The method of claim 2 wherein the binder is selected from the group consisting of: substituted celluloses, celluloses, the polyvinyl alcohols, polyethylenoxides, the polyacrylonitriles, polysaccharides, nitrocelluloses, polyvinylpyrrolidone, or combinations thereof.

14. The method of claim 1 wherein the polar solvent is an organic solvent.

15. The method of claim 1 wherein the polar solvent is selected from the group consisting of: aliphatic alcohols, the polyglycols, polyethers, polyols, esters, ethers, ketones, nitriles, alkoxyalcohols, iso-propyl alcohol, or combinations thereof.

16. The method of claim 1 wherein processing comprises annealing with a ramp-rate of 1-5 C/sec, preferably over 5 C/sec, to a temperature of about 225 to 550° C.

17. The method of claim 1 wherein processing comprises annealing with a ramp-rate of 1-5 C/sec, preferably over 5 C/sec, to a temperature of about 225 to 550° C. preferably for about 30 seconds to about 600 seconds to enhance conversion of indium hydroxide, densification and/or alloying between Cu, In, and Ga in an atmosphere containing hydrogen gas, where the plateau temperature not necessarily is kept constant in time.

18. The method of claim 1 wherein processing further comprise selenizing this annealed layer with a ramp-rate of over 5 C/sec, to a temperature of about 225 to 575 C for a time period of about 60 seconds to about 10 minutes in Se vapor in a non-vacuum atmosphere, where the plateau temperature not necessarily is kept constant in time, to form the thin-film containing one or more chalcogenide compounds containing Cu, In, Ga, and Se.

19. The method of claim 1 wherein processing comprise selenizing without the separate annealing step in an atmosphere containing hydrogen gas, but may be densified and selenized in one step with a ramp-rate of over 5 C/sec, to a temperature of 225 to 575 C for a time period of about 120 seconds to about 20 minutes in an atmosphere containing either H2Se or a mixture of H2 and Se vapor in a non-vacuum pressure.
